(19) United States
(12) Patent Application Publication
(10) Pub. No.: US 2015/0312796 A1
(43) Pub. Date: Oct. 29, 2015

(54) WIRELESS COMMUNICATION TERMINAL AND METHOD FOR ESTIMATING NETWORK COMMUNICATION LOAD IN COMMUNICATION NETWORK

(71) Applicant: NEC Corporation, Minato-ku, Tokyo (JP)

(72) Inventors: Jun SHIKIDA, Tokyo (JP); Hiroto SUGAHARA, Tokyo (JP); Hiroaki AMINAKA, Tokyo (JP)

(73) Assignee: NEC Corporation, Tokyo (JP)

(21) Appl. No.: 14/650,045

(22) PCT Filed: Dec. 6, 2013
(86) PCT No.: PCT/JP2013/007211

§ 371 Date: Jun. 5, 2015

(30) Foreign Application Priority Data
Dec. 6, 2012 (JP) 2012-267717

(51) Int. Cl. H04W 28/02; H04J 13/00; H04L 5/00; H04B 17/26

(52) U.S. Cl. CPC H04W 28/0247; H04B 17/26; H04J 13/00; H04L 5/005

(57) ABSTRACT

A method for estimating a network communication load without performing actual communication and a wireless communication terminal are provided. A wireless communication terminal (10) connectable to a network (NW) includes a load estimation section (14), and the load estimation section (14) estimates a communication load of the network NW by using a first quality index that does not depend on a network communication load and a second communication index that depends on a network communication load.

### TECHNICAL FIELD

The present invention relates to a communication network system and, more particularly, to a wireless communication terminal and a method for estimating a network communication load for the wireless communication terminal.

### BACKGROUND ART

In recent years, mobile communication is in a situation of a plurality of systems coexisting such as WCDMA (Wideband Code Division Multiple Access), LTE (Long Term Evolution), and public wireless LAN (Local Area Network). Moreover, in a cellular network, a plurality of communication operators (operators) also coexist. Hereinafter, for convenience of description, a communication system and an operator in an environment such that a plurality of communication systems and a plurality of operators coexist will be collectively referred to as “network”.

In an environment in which a plurality of networks coexist, a user selects one network according to the situation and thereby can expect improvement in communication quality such as throughput. Such network selection can be achieved by monitoring the reception quality of reference signals, carrier signals and the like transmitted from other networks. Known reception quality to be measured by user equipment includes, for example, RSRP (Reference Signal Received Power), RSRQ (Reference Signal Received Quality), RSCP (Reference Signal Code Power), RSSI (Received Signal Strength Indicator), Ec/No (Energy per chip/Noise) and the like (see NPL 1).

### CITATION LIST

### Patent Literature

### [NPL 1]

3GPP TS 36.214 v10.1.0 (2011-01), Sec. 5.1, pp. 7-8

### SUMMARY OF INVENTION

### Technical Problem

However, throughput depends on not only reception quality but also network loads such as the number of communicating users. For example, even a network presenting good reception quality, if a number of users are using the network, may be short of resources with the possible result that throughput cannot be improved. Moreover, throughput is unknown unless communication is actually performed. Accordingly, if an attempt is made to obtain throughput for a plurality of networks, a mobile station needs to establish communication with the networks at each such attempt, causing increases in power consumption of user equipment, network loads and the like.

Accordingly, an object of the present invention is to provide a wireless communication terminal and a method for estimating a network communication load without the actual performance of communication.

### Solution to Problem

A method for estimating a network communication load according to the present invention is characterized in that a wireless communication terminal estimates a communication load of a network by using a first quality index that does not depend on a network communication load and a second quality index that depends on a network communication load.

A wireless communication terminal according to the present invention is a wireless communication terminal that can connect to at least one network, characterized by comprising: load estimation means for estimating a communication load of the network by using a first quality index that does not depend on a network communication load and a second quality index that depends on a network communication load.

A communication system according to the present invention is a communication system comprising at least one network and a wireless communication terminal that can connect to the network, characterized in that the wireless communication terminal estimates a communication load of the network by using a first quality index that does not depend on a network communication load and a second quality index that depends on a network communication load.

### Advantageous Effects of Invention

According to the present invention, a network communication load is estimated by using a first quality index that does not depend on a network communication load and a second quality index that depends on a network communication load, whereby it is possible to estimate the network load without the actual performance of communication.

### BRIEF DESCRIPTION OF DRAWINGS

FIG. 1 is a block diagram showing a functional configuration of a wireless communication terminal according to a first exemplary embodiment of the present invention.

FIG. 2 is a flowchart showing a method for load estimation according to the first exemplary embodiment.

FIG. 3 is a diagram of a resource block structure for describing an example in which the method for load estimation according to the first exemplary embodiment is provided to an LTE system.

FIG. 4 is a schematic diagram showing a signal generation process for describing an example in which the method for load estimation according to the first exemplary embodiment is provided to a WCDMA system.

FIG. 5 is a schematic diagram illustrating a method for limiting the number of cells according to a second exemplary embodiment of the present invention.

FIG. 6 is a flowchart showing an example of the method for limiting the number of cells according to the second exemplary embodiment.

FIG. 7 is a block diagram showing a functional configuration of a wireless communication terminal according to a third exemplary embodiment of the present invention.

FIG. 8 is a flowchart showing operations of the wireless communication device according to the third exemplary embodiment.

FIG. 9 is a graph showing changes over time in a quality index to describe an example of statistical processing of the quality index in the third exemplary embodiment.

FIG. 10 is a block diagram showing a functional configuration of a wireless communication terminal according to a fourth exemplary embodiment of the present invention.

FIG. 11 is a flowchart showing operations of the wireless communication device according to the fourth exemplary embodiment of the present invention.

FIG. 12 is a graph showing changes over time in a load to describe an example of statistical processing of a quality index in the fourth exemplary embodiment.

FIG. 13 is a graph showing changes over time in a load to describe another example of the statistical processing of a quality index in the fourth exemplary embodiment.

FIG. 14 is a diagram of a network architecture in which a wireless communication terminal according to a fifth exemplary embodiment of the present invention is used.

FIG. 15 is a block diagram showing a schematic configuration of the wireless communication terminal according to the fifth exemplary embodiment.

FIG. 16 is a flowchart showing operations of the wireless communication terminal according to the fifth exemplary embodiment.

FIG. 17 is a diagram of a network architecture in which wireless communication terminals according to a sixth exemplary embodiment of the present invention are used.

FIG. 18 is a diagram of a network architecture in which wireless communication terminals according to a seventh exemplary embodiment of the present invention are used.

FIG. 19 is a block diagram showing a schematic configuration of the router-side wireless communication terminal according to the seventh exemplary embodiment.

FIG. 20 is a sequence diagram showing system operations in the seventh exemplary embodiment.

FIG. 21 is a diagram of a network architecture in which wireless communication terminals according to an eighth exemplary embodiment of the present invention are used.

FIG. 22 is a sequence diagram showing system operations in the eighth exemplary embodiment.

FIG. 23 is a diagram of a network architecture in which wireless communication terminals according to a ninth exemplary embodiment of the present invention are used.

FIG. 24 is a sequence diagram showing system operations in the ninth exemplary embodiment.

FIG. 25 is a schematic diagram for describing criteria for network selection by a wireless communication terminal according to the ninth exemplary embodiment.

FIG. 26 is a flowchart showing operations of the wireless communication terminal according to the ninth exemplary embodiment.

FIG. 27 is a block diagram showing an example of the configuration of any wireless communication terminal according to the fifth to ninth exemplary embodiments.

### DESCRIPTION OF EMBODIMENTS

According to an exemplary embodiment of the present invention, a wireless communication terminal estimates a network communication load, based on a quality index that does not depend on a network communication load and a quality index that depends on a network communication load. Since the communication load can be estimated based on measured values of the quality indexes, it is unnecessary to actually connect to a network, and it is thus possible to suppress increases in the power consumption of the wireless communication terminal, the network load and the like. Hereinafter, exemplary embodiments and examples of the present invention will be described in detail with reference to drawings.

### 1. First Exemplary Embodiment

### 1.1) Configuration

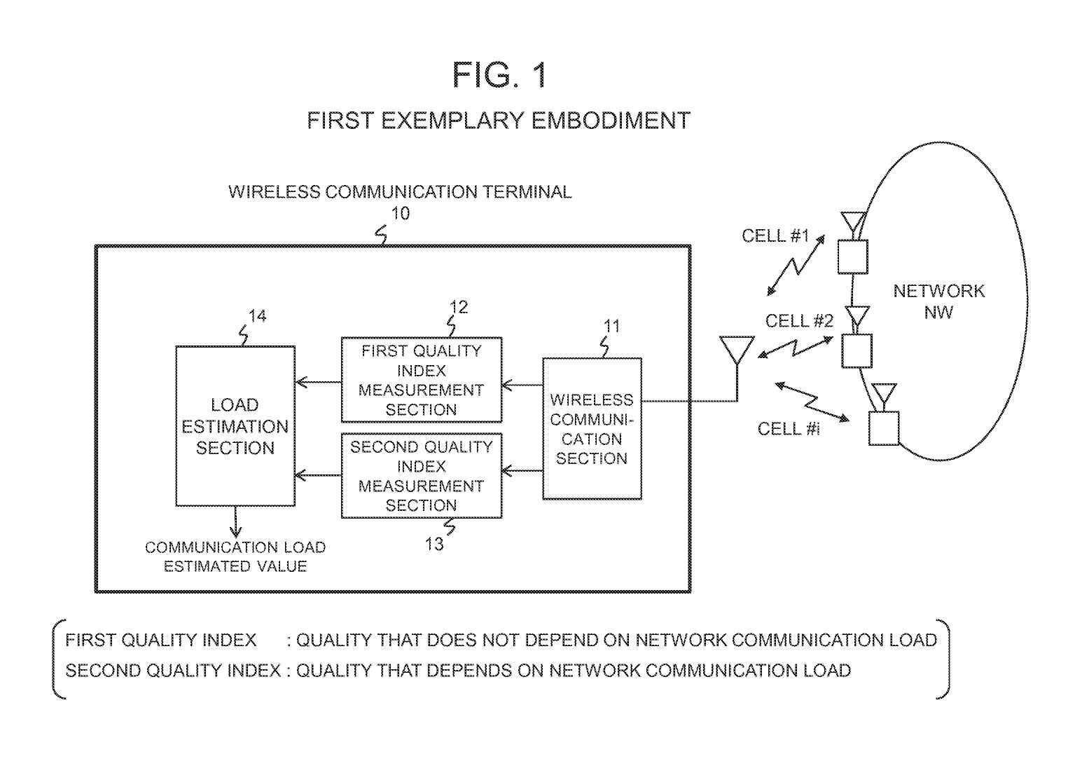

Referring to FIG. 1, a wireless communication terminal 10 according to a first exemplary embodiment of the present invention has a functional configuration including a wireless communication section 11, a first quality index measurement section 12, a second quality index measurement section 13, and a load estimation section 14. The wireless communication section 11 can wirelessly connect to a network NW, and the first quality index measurement section 12 and second quality index measurement section 13 individually measure reception quality, which will be described next, by using signals received from the network NW by the wireless communication section 11.

A first quality index to be measured by the first quality index measurement section 12 is a quality index that does not depend on a network communication load and is, for example, RSRP, RSCP or the like. A second quality index to be measured by the second quality index measurement section 13 is a quality index that depends on the network communication load and is, for example, RSRQ, Ec/No or the like. An estimated value of the communication load of the network NW, which is obtained by the load estimation section 14, is, for example, a resource use rate or the like.

The load estimation section 14 estimates the communication load of the network NW by using the first and second quality indexes measured by the first quality index measurement section 12 and second quality index measurement section 13, respectively.

### 1.2) Operations

It is assumed that the wireless communication terminal 10 shown in FIG. 1 is provided with a control section for controlling operations of the terminal and a storage section for storing data (both are not shown), and the control section controls a load estimation operation, which will be described next.

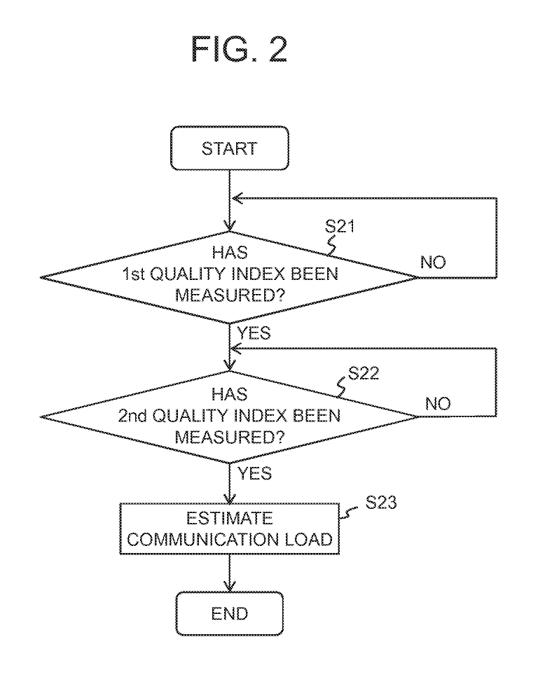

Referring to FIG. 2, the control section determines whether or not the first quality index measurement section 12 has measured the first quality index (Operation S21) and, if the first quality index has been measured and its measured value is stored in the storage section (Operation S21; YES), determines whether or not the second quality index measurement section 13 has measured the second quality index (Operation S22). If the second quality index has been measured and its measured value is stored in the storage section (Operation S22; YES), the control section controls the load estimation section 14, so that the load estimation section 14 estimates the communication load of the network NW by using the first and second quality index measured values (Operation S23). In these operations, the order of measurement of the first and second quality indexes may be interchanged.

### 1.3) Load Estimation

Next, a method for load estimation by the load estimation section 14 will be described concretely by illustrating the cases of LTE and WCDMA.

### 1.3a) Load Estimation (in Case of LTE)

Hereinafter, a description will be given of a case where a network load u (resource use rate) is estimated by using RSRP as the first quality index that does not depend on the network communication load, and RSRQ as the second quality index that desponds on the network communication load.

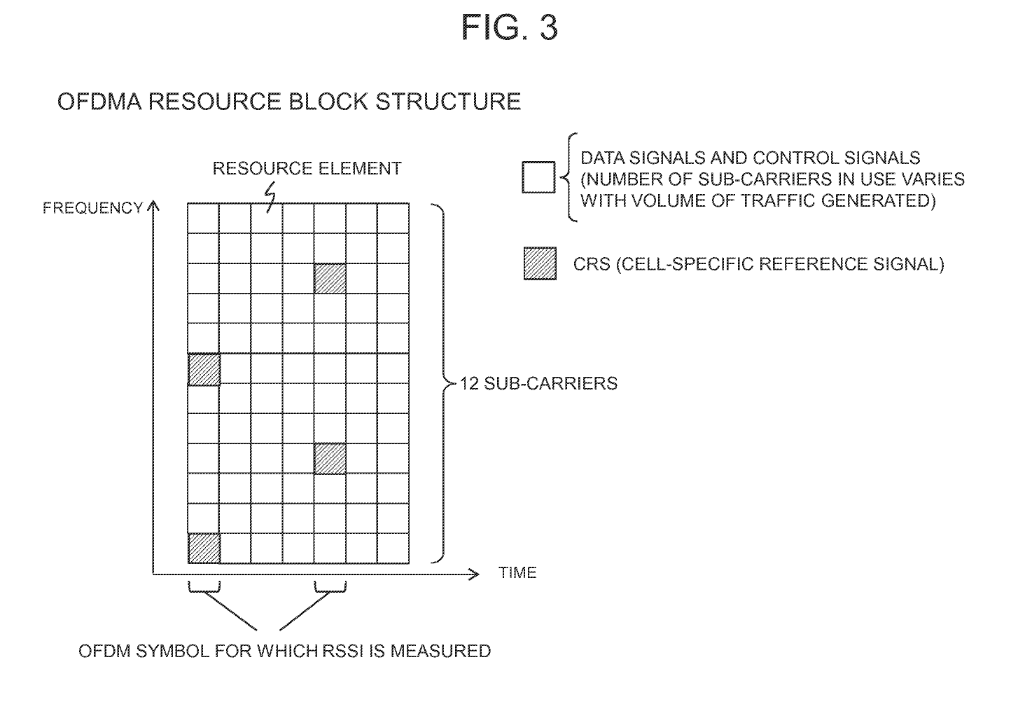

Using an OFDMA (Orthogonal Frequency Division Multiple Access) resource block structure as shown in FIG. 3, RSSI and the quality indexes, RSRP and RSRQ, are defined as follows (see NPL 1). However, the resource block structure in FIG. 3 is a structure in case of a single transmission antenna.

RSSI: The received signal power of an OFDM symbol with a reference signal RS multiplexed, which therefore depends on the network communication load.

RSRP: The received signal power of a cell-specific reference signal CRS per resource element, which therefore does not depend on the network communication load.

RSRQ: The number of resource blocks (RBs)×RSRP/RSSI. Since RSSI depends on the network communication load, RSRQ also depends on the network communication load.

Assuming that all sub-carriers have the same transmission power and that the transmission signals of individual cells have no correlation to each other in an OFDM symbol shown in FIG. 3, then RSSI can be expressed by the following equation (1):

$$\begin{matrix}[ Math . 1 ] & \\ RSSI = N \cdot \{ {\sum }_{k = 1}^{K} ( 2 {p}_{k} + 10 {p}_{k} {u}_{k} ) + Noise \} & ( 1 )\end{matrix}$$

where N is the number of RBs, K is the number of cells, pₖ is the RSRP of a k-th cell, uₖ is the resource use rate (network load) of the k-th cell, and Noise is noise power per RB. In the equation (1), 2pₖ represents the RSRP of two CRSs as shown in FIG. 3, and 10pₖuₖ represents the RSRP considering the resource use rate of 10 sub-carriers other than the CRSs. Note that the 10 sub-carriers other than the CRSs are assigned to data signal and control signal, and the number of sub-carriers in use varies with the volume of traffic generated.

If the equation (1) above is modified into the following equation (2):

$$\begin{matrix}[ Math . 2 ] & \\ RSSI = N \cdot \{ {\sum }_{k = 1}^{K} 2 {p}_{k} ( 1 + 5 {u}_{k} ) + Noise \} & ( 2 )\end{matrix}$$

and further assuming that the resource use rates uₖ of all cells are identical (=u), then the following equation (3) is obtained:

$$\begin{matrix}[ Math . 3 ] & \\ RSSI = N \cdot \{ 2 \cdot ( 1 + 5 u ) {\sum }_{k = 1}^{K} {p}_{k} + Noise \} & ( 3 )\end{matrix}$$

When the equation (3) is solved for u and rewritten by using the above-mentioned RSRQ definition: qₖ=N×pₖ/RSSI, the resource use rate u can be expressed as follows:

$$\begin{matrix}[ Math . 4 ] & \\ u = \frac{1}{5} ( \frac{\frac{{p}_{l}}{{q}_{l}} - Noise}{2 {\sum }_{k = 1}^{K} {p}_{k}} - 1 ) & ( 4 )\end{matrix}$$

where qₖ is the RSRQ (qₖ=N×pₖ/RSSI) of the k-th cell. The index I in p_{I}/q_{I} is an arbitrary value not larger than K, which indicates a cell, but it is preferable to use a cell with larger RSRP and RSRQ values.

As shown in the equation (4) above, the resource use rate u, which represents the network load, can be obtained by using the first quality index RSRP that does not depend on the network communication load and the second quality index RSRQ that depends on the network communication load. Note that although the case of a single transmission antenna is described as an example here, the equation (4), if coefficients are changed, can also be applied in case where the number of transmission antennas is two or more.

### 1.3b) Load Estimation (in Case of WCDMA)

Next, a description will be given of a case where a network load u (the average number of concurrently multiplexed users) is estimated by using RSCP as the first quality index that does not depend on the network communication load, and Ec/No as the second quality index that depends on the network communication load.

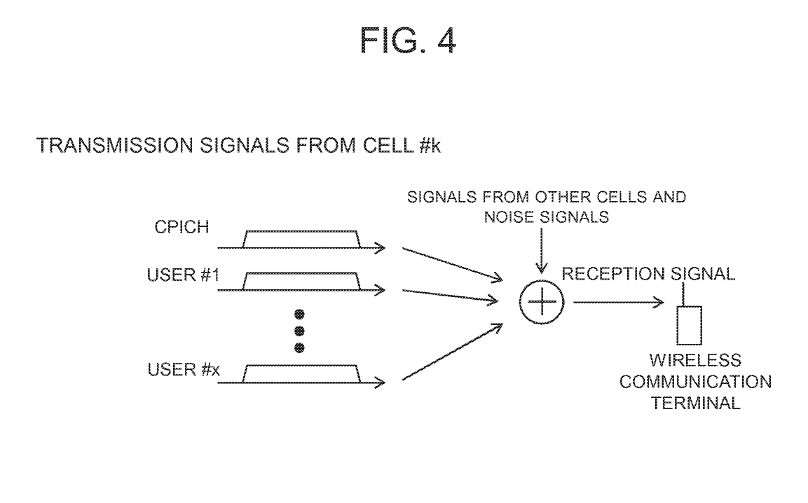

Referring to FIG. 4, a common pilot channel CPICH of a cell #k and transmission signals of users #1-#x are multiplexed by means of CDM. The multiplexed CPICH and transmission signals to which signals of other cells and noise signals are added are received by a wireless communication terminal.

In such WCDMA, RSSI and the quality indexes, RSCP and Ec/No, are defined as follows (see NPL 1).

RSSI: The received signal power within the frequency band.

RSCP: The received signal power of the common pilot channel (CPICH).

Ec/No: The ratio of RSCP to RSSI (Ec/No=RSCP/RSSI).

Assuming that the CPICH and user signals have the same transmission power and that the individual transmission signals have no correlation to each other, then RSSI can be expressed by the following equation (5):

$$\begin{matrix}[ Math . 5 ] & \\ RSSI = \{ {\sum }_{k = 1}^{K} ( {p}_{k} + {p}_{k} {u}_{k} ) + Noise \} & ( 5 )\end{matrix}$$

where K is the number of cells, pₖ is the RSCP of a k-th cell, uₖ is the average number of concurrently multiplexed users (network load) in the k-th cell, and Noise is the noise power within the band.

If the equation (5) above is modified into the following equation (6):

$$\begin{matrix}[ Math . 6 ] & \\ RSSI = \{ {\sum }_{k = 1}^{K} {p}_{k} ( 1 + {u}_{k} ) + Noise \} & ( 6 )\end{matrix}$$

and further assuming that the average number of concurrently multiplexed users uₖ in all cells are identical (=u), then the following equation (7) is obtained:

$$\begin{matrix}[ Math . 7 ] & \\ Rssi = ( 1 + u ) {\sum }_{k = 1}^{K} {p}_{k} + Noise & ( 7 )\end{matrix}$$

When the equation (7) is solved for u and rewritten by using the above-mentioned Ec/No definition: Ec/No=pₖ/RSSI, the average number of concurrently multiplexed users u can be expressed as follows:

$$\begin{matrix}[ Math . 8 ] & \\ u = \frac{\frac{{p}_{l}}{{E}_{c} / {N}_{o} ( l )}}{{\sum }_{k = 1}^{K} {p}_{k}} - 1 & ( 8 )\end{matrix}$$

where Ec/No(I) is the Ec/No of an l-th cell. The index I is an arbitrary value, but it is preferable to use a cell with larger RSCP and Ec/No values.

As shown in the equation (8) above, the average number of concurrently multiplexed users u, which represents the network load, can be obtained by using the first quality index RSCP that does not depend on the network communication load and the second quality index Ec/No that depends on the network communication load.

### 1.3c) Load Estimation (Other Examples)

In addition to LTE and WCDMA described above, it is possible to use Ec, Ec/lo, and Pilot Strength for quality indexes in case of cdma2000, and to use Preamble RSSI and CINR for quality indexes in case of WiMAX.

### 1.4) Effects

As described above, according to the first exemplary embodiment of the present invention, it is possible to estimate a network load without actually connecting to a network, and consequently it is possible to suppress increases in the power consumption of a wireless communication terminal and the network load.

### 2. Second Exemplary Embodiment

According to a second exemplary embodiment of the present invention, the amount of calculation by the load estimation section 14 can be suppressed by reducing the number of cells used for load estimation in the first exemplary embodiment. Hereinafter, limitation on the number of cells will be described mainly.

### 2.1) Configuration

The configuration of a wireless communication terminal according to the second exemplary embodiment is similar to that of the first exemplary embodiment shown in FIG. 1, and therefore a description thereof will be omitted. However, the amount of calculation by the load estimation section 14 is reduced due to limitation on the number of cells, which will be described next.

### 2.2) Limitation on the Number of Cells

In the calculation for load estimation in the first exemplary embodiment described above, the first quality index (RSRP in case of LTE, or RSCP in case of WCDMA) needs to be added up for all cells, as shown in the equations (4) and (8). However, for example in the equation (4), the sum of the RSRPs of all cells used for load estimation depends on those cells with larger RSRP, and elements with smaller RSRP can be ignored. Accordingly, the addition processing is restricted to those cells with larger values of the first quality index, whereby it is expected to achieve a reduction in the amount of calculation without impairing the accuracy of load estimation. Hereinafter, examples of a method for limiting the number of cells will be illustrated.

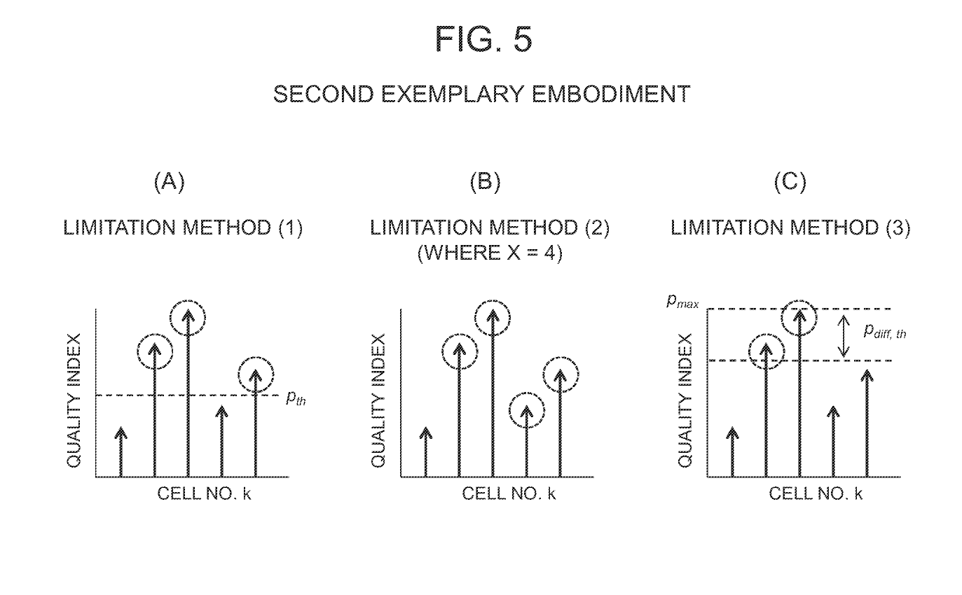

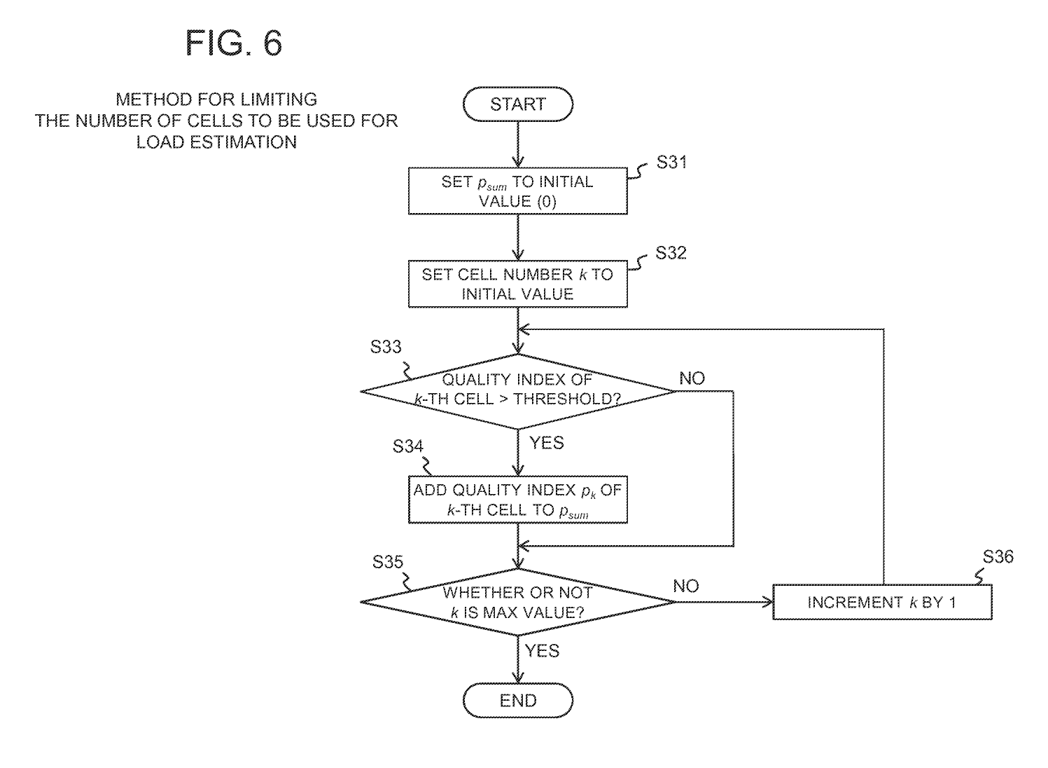

In a limitation method (1) shown in FIG. 5(A), cells are limited to those with the first quality index pₖ larger than a threshold pₜₕ. In a limitation method (2) shown in FIG. 5(B), cells are limited to top x cells in descending order of the first quality index pₖ (in this example, x=4). In a limitation method (3) shown in FIG. 5(C), compared with a cell exhibiting the largest first quality index, cells are limited to those with a quality index difference p_{diff,k} (=pₘₐₓ−pₖ) smaller than a threshold p_{diff, th}. Hereinafter, a description will be given of operations in the addition processing when the limitation method (1) shown in FIG. 5(A) is used as an example, with reference to FIG. 6.

Referring to FIG. 6, the load estimation section 14 initializes pₛᵤₘ, which represents a result of the addition processing, to 0 (Operation S31) and also initializes the cell number k (Operation S32). Subsequently, the load estimation section 14 determines whether or not the first quality index pₖ of a k-th cell is larger than the threshold pₜₕ (Operation S33) and, when pₖ>pₜₕ (Operation S33; YES), adds this first quality index pₖ to pₛᵤₘ (Operation S34), but, when pₖ is not larger than pₜₕ (Operation S33; NO), does not perform Operation S34 for addition to pₛᵤₘ. Subsequently, the load estimation section 14 determines whether or not the cell number k has reached a maximum value (Operation S35) and, if the cell number k has not reached the maximum value (Operation S35; NO), increments the cell number k by 1 (Operation S36) and then returns to Operation S33. The above-described Operations S33 to S36 are repeated until the cell number k reaches the maximum value, and when it has reached, the processing is completed (Operation S35; YES).

### 2.3) Effects

As described above, according to the second exemplary embodiment of the present invention, in addition to the effects of the first exemplary embodiment, in the addition processing for calculating pₛᵤₘ, cells subject to the addition processing can be limited (for example, only to those cells with the first quality index larger than the threshold pₘ) by using limitation methods as shown in FIG. 5 as examples. Accordingly, the amount of calculation by the load estimation section 14 can be suppressed.

### 3. Third Exemplary Embodiment

According to a third exemplary embodiment of the present invention, to suppress the variation of results of load estimation, load estimation is carried out after statistical processing is performed on the measured quality indexes.

### 3.1) Configuration

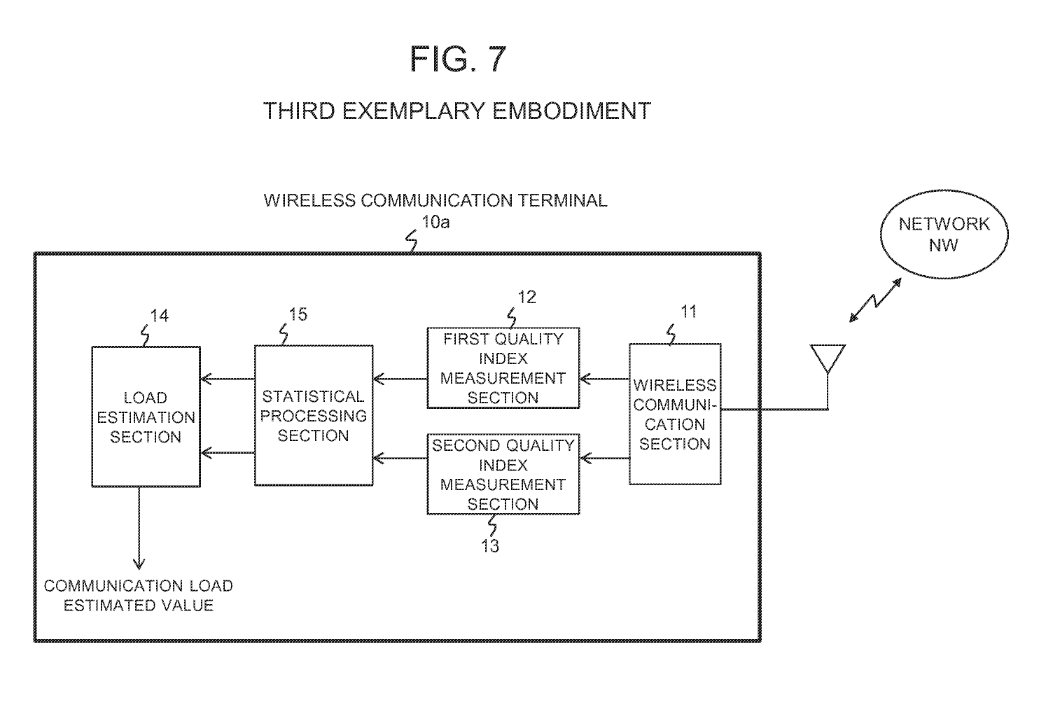

Referring to FIG. 7, a wireless communication terminal 10a according to a third exemplary embodiment of the present invention has a configuration in which a statistical processing section 15 is provided prior to the load estimation section 14 in the wireless communication terminal 10 according to the first exemplary embodiment shown in FIG. 1. Accordingly, the blocks having the same functions as those of the first exemplary embodiment are given the same reference signs, and a description thereof will be omitted. Note that it is also possible to apply limitation on the number of cells as in the second exemplary embodiment to the load estimation section 14.

### 3.2) Operations

It is assumed that the wireless communication terminal 10a shown in FIG. 7 is provided with a control section for controlling operations of the terminal and a storage section for storing data (both are not shown), and the control section controls a load estimation operation, which will be described next.

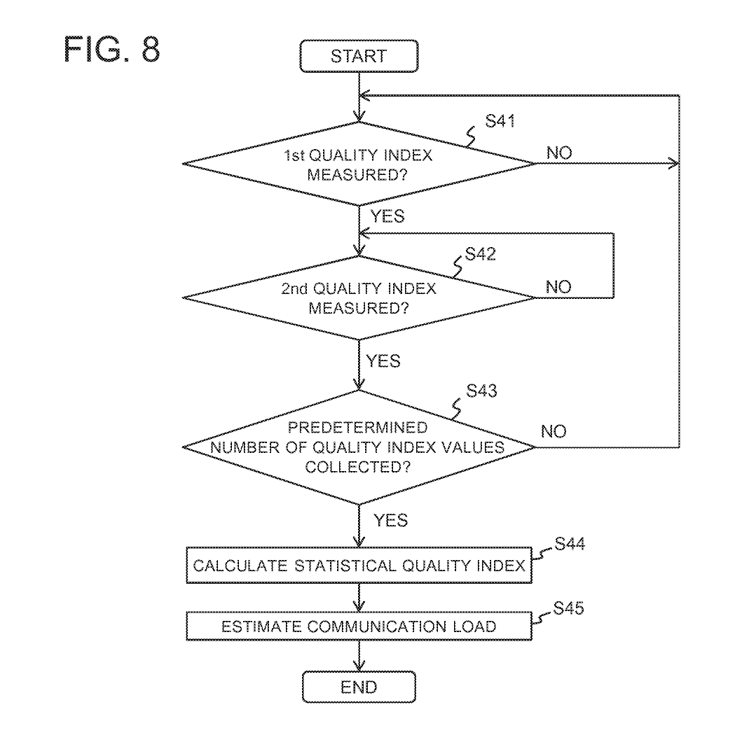

Referring to FIG. 8, the control section determines whether or not the first quality index measurement section 12 has measured the first quality index (Operation S41) and, if the first quality index has been measured and its measured value is stored in the storage section (Operation S41; YES), determines whether or not the second quality index measurement section 13 has measured the second quality index (Operation S42). If the second quality index has been measured and its measured value is stored in the storage section (Operation S42; YES), the control section determines whether or not a predetermined number of quality index measured values are collected in the statistical processing section 15 (Operation S43) and repeats the above-described Operations S41 and S42 until the predetermined number of them are collected (Operation S43; NO). When the predetermined number of quality index measured values have been collected (Operation S43; YES), the statistical processing section 15 performs statistical processing for averaging, weighing and the like on the predetermined number of first quality index measured values and the predetermined number of second quality index measured values (Operation S44) and outputs the first and second quality indexes having undergone statistical processing to the load estimation section 14. The load estimation section 14 estimates the communication load of the network NW as described above by using the first and second quality indexes having undergone statistical processing (Operation S45).

### 3.3) Statistical Processing

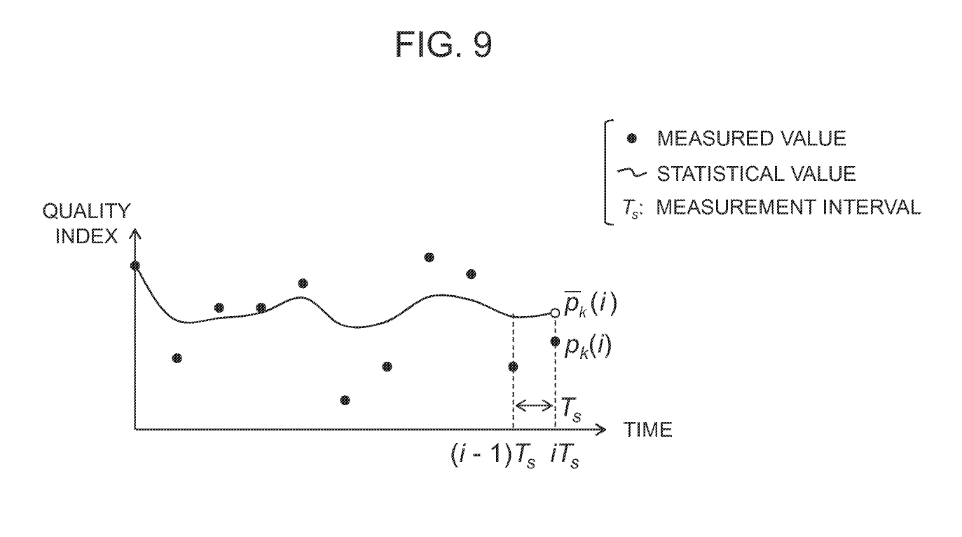

As schematically shown in FIG. 9, the first quality index measurement section 12 and second quality index measurement section 13 measure the respective quality indexes at measurement intervals Tₛ. However, their measured values pₖ vary over time in actuality, and a measured value pₖ(i) at a sampling time point i does not always reflect actual quality and may deviate greatly. Accordingly, such measured values are collected for a certain period of time and are subject to statistical processing, whereby it is possible to suppress the variation of measured values over time, as shown at statistical values pₖ(i) in FIG. 9.

Averaging or weighting processing or the like can be used for the statistical processing, which can be expressed in general by the following equation (9):

$$\begin{matrix}[ Math . 9 ] & \\ {\overline{p}}_{k} ( i ) = {\sum }_{j = 0}^{{N}_{samp} - 1} {w}_{j} {p}_{k} ( i - j ) / {\sum }_{j = 0}^{{N}_{samp} - 1} {w}_{j} & ( 9 )\end{matrix}$$

where \ddot{p}ₖ is a quality index statistical value, Nₛₐₘₚ is the number of samples, wⱼ is a weighting coefficient, and pₖ is a quality index measured value.

The number of samples Nₛₐₘₚ and the weighting coefficient wⱼ can be determined depending on the varying states of measured values over time. For example, the number of samples Nₛₐₘₚ is made larger when it is attempted to suppress variation, and the weighing coefficient wⱼ is made to have a larger value as j becomes smaller when it is attempted to make the latest measured values have greater effects.

### 3.4) Effects

As described above, according to the third exemplary embodiment of the present invention, in addition to the effects of the above-described first and second exemplary embodiments, the variation of results of load estimation over time can be suppressed by carrying out load estimation after statistical processing is performed on the measured quality indexes, whereby more reliable load estimation can be achieved.

### 4. Fourth Exemplary Embodiment

A fourth exemplary embodiment of the present invention, although it is aimed to suppress the variation of results of load estimation over time as in the third exemplary embodiment, provides another method for solution and uses a plurality of results of load estimation obtained according to the first to third exemplary embodiments to suppress variation over time. Hereinafter, a detailed description will be given.

### 4.1) Configuration

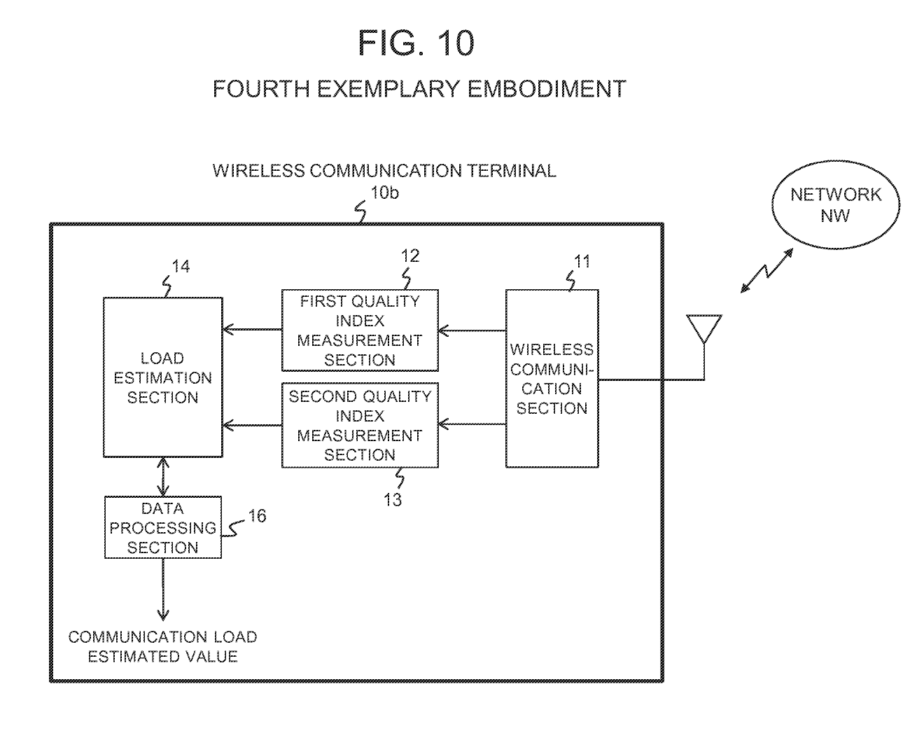

Referring to FIG. 10, a wireless communication terminal 10b according to the fourth exemplary embodiment of the present invention has a configuration in which a data processing section 16 is added to the wireless communication terminal 10 according to the first exemplary embodiment shown in FIG. 10. The data processing section 16 performs statistical processing or selection processing on estimated values, which will be described later, and thereby can suppress the variation of results of estimation over time. Accordingly, the blocks having the same functions as those of the first exemplary embodiment are given the same reference signs, and a description thereof will be omitted. However, limitation on the number of cells as described in the second exemplary embodiment may be applied to the load estimation section 14.

### 4.2) Operations

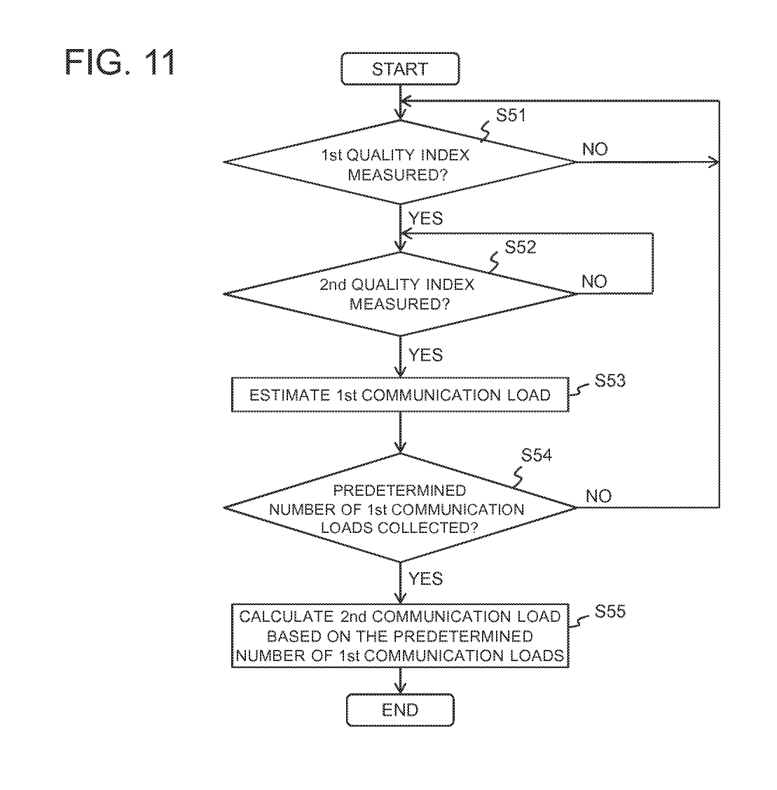

Referring to FIG. 11, the control section determines whether or not the first quality index measurement section 12 has measured the first quality index (Operation S51) and, if the first quality index has been measured and its measured value is stored in the storage section (Operation S51; YES), determines whether or not the second quality index measurement section 13 has measured the second quality index (Operation S52). If the second quality index has been measured and its measured value is stored in the storage section (Operation S52; YES), the control section controls the load estimation section 14, so that the load estimation section 14 estimates a first communication load based on the above-mentioned measured values (Operation S53). An estimated value of the first communication load is a result of load estimation obtained according to the above-described first and second exemplary embodiments. Subsequently, the control section determines whether or not a predetermined number of first communication load estimated values are collected (Operation S54) and repeats the above-described Operations S51 to S53 until the predetermined number of them are collected (Operation S54; NO). When the predetermined number of first communication load estimated values have been collected (Operation S54; YES), the control section controls the data processing section 16, so that the data processing section 16 performs statistical processing and selection processing on the predetermined number of first communication load estimated values, which will be described below, thereby calculating the communication load (second communication load) on the network NW (Operation S55).

### 4.3) Statistical Processing

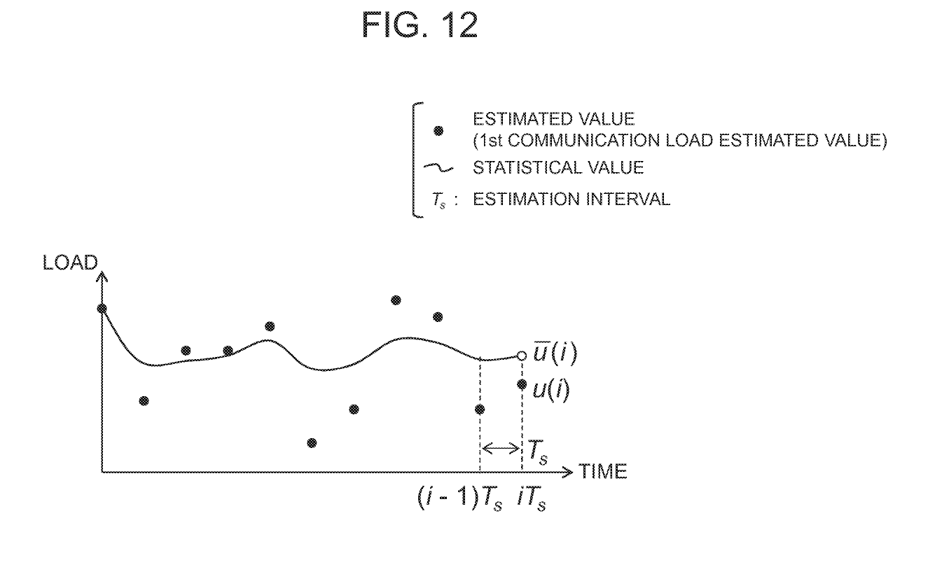

In the above-described first and second exemplary embodiments, the first communication load estimated values u(i) are obtained based on the measured first and second quality indexes at measurement intervals Tₛ as schematically shown in FIG. 12. However, as described already, the first communication load estimated values u(i) vary over time in actuality, and u(i) at a certain sampling time point i does not always reflect an actual load and may deviate greatly. Accordingly, such first communication load estimated values are collected for a certain period of time and are subject to statistical processing, whereby it is possible to suppress the variation of estimated values over time, as shown at statistical values u(i) in FIG. 11.

Averaging or weighting processing or the like can be used for the statistical processing, which can be expressed in general by the following equation (10):

$$\begin{matrix}[ Math . 10 ] & \\ \overline{u} ( i ) = {\sum }_{j = 0}^{{N}_{samp} - 1} {w}_{j} u ( i - j ) / {\sum }_{j = 0}^{{N}_{samp} - 1} {w}_{j} & ( 10 )\end{matrix}$$

where \vec{u} is a communication load statistical value, Nₛₐₘₚ is the number of samples, wⱼ is a weighting coefficient, and u is a first communication load estimated value.

The number of samples Nₛₐₘₚ and the weighting coefficient wⱼ can be determined depending on the varying states of measured values over time. For example, the number of samples Nₛₐₘₚ is made larger when it is attempted to suppress variation, and the weighing coefficient wⱼ is made to have a larger value as j becomes smaller when it is attempted to make the latest estimated values have greater effects.

### 4.4) Selection Processing

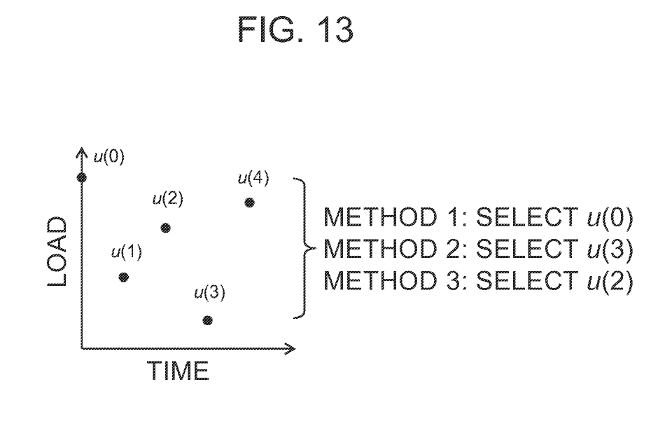

It is also possible to suppress the variation of results of load estimation over time by selecting one load estimated value from the plurality of first communication load estimated values u(i) that are estimated by the data processing section 16 at different time points, as schematically shown in FIG. 13. For example, in a method 1, the largest value is selected from the plurality of first communication load estimated values u(i); in a method 2, the smallest value is selected; in method 3, the median value is selected.

### 4.5) Effects

As described above, according to the fourth exemplary embodiment of the present invention, statistical processing or selection processing is performed on the first load estimated values obtained according to the above-described first or second exemplary embodiment, whereby it is possible to suppress the variation of results of load estimation over time, and it is thus possible to achieve more reliable load estimation.

### 5. Fifth Exemplary Embodiment

A wireless communication terminal according to a fifth exemplary embodiment of the present invention is a multi-network-capable terminal that is capable of connecting to a plurality of networks and includes the load estimation function according to the above-described exemplary embodiments and thus can select an appropriate network. Hereinafter, a detailed description will be given.

### 5.1) System Architecture

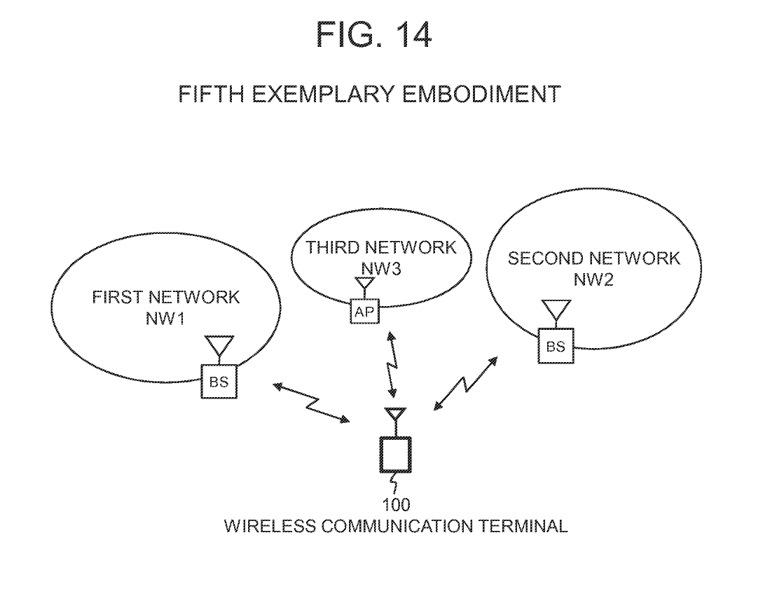

Referring to FIG. 14, it is assumed that a wireless communication terminal 100 according to the present exemplary embodiment is capable of connecting to a plurality of networks. As an example, three networks NW1, NW2, and NW3 shown in FIG. 14 are, for example, a cellular network, a public wireless LAN and the like provided by operators (mobile operators or wireless service providers).

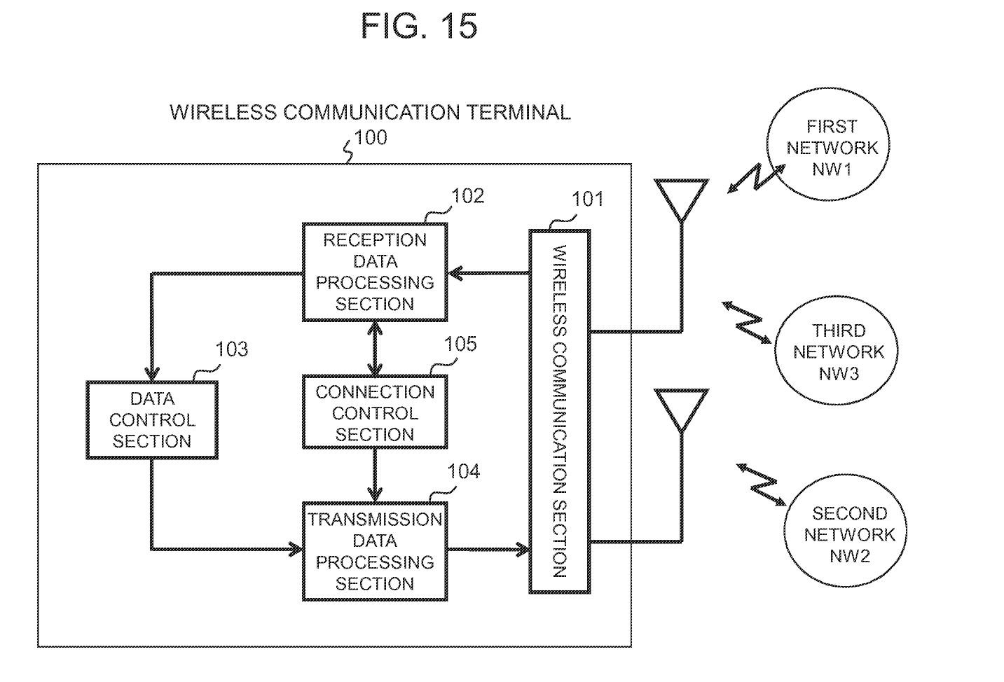

Referring to FIG. 15, a wireless communication section 101 of the wireless communication terminal 100 can wirelessly connect to a base station or an access point of the network NW1, NW2, or NW3 by means of a predetermined wireless access scheme (e.g., URAN (UMTS Terrestrial Radio Access Network), E-UTRAN (Evolved UTRAN), GERAN (GSM EDGE Radio Access. Network), WiMAX (Worldwide Interoperability for Microwave Access), Wireless LAN or the like).

The wireless terminal 100 further includes a reception data processing section 102, a data control section 103, a transmission data processing section 104, and a connection control section 105. The reception data processing section 102 and transmission data processing section 104 performs processing of data received from and to be sent to a connected network in accordance with control by the connection control section 105. The data control section 103 performs control and the like of the transmission data processing section 104 according to the received data.

The reception data processing section 102, which has the functions of the first quality index measurement section 12 and second quality index measurement section 13 described above, measures the first and second quality indexes and outputs their measured values to the connection control section 105. The connection control section 105, which has the functions of the load estimation section 14 and statistical processing section 15 and/or data processing section 16 described above, estimates the communication loads on the networks NW by using the first and second quality index measurement values from the reception data processing section 102 and selects a network to use based on results of this estimation.

### 5.2) Operations

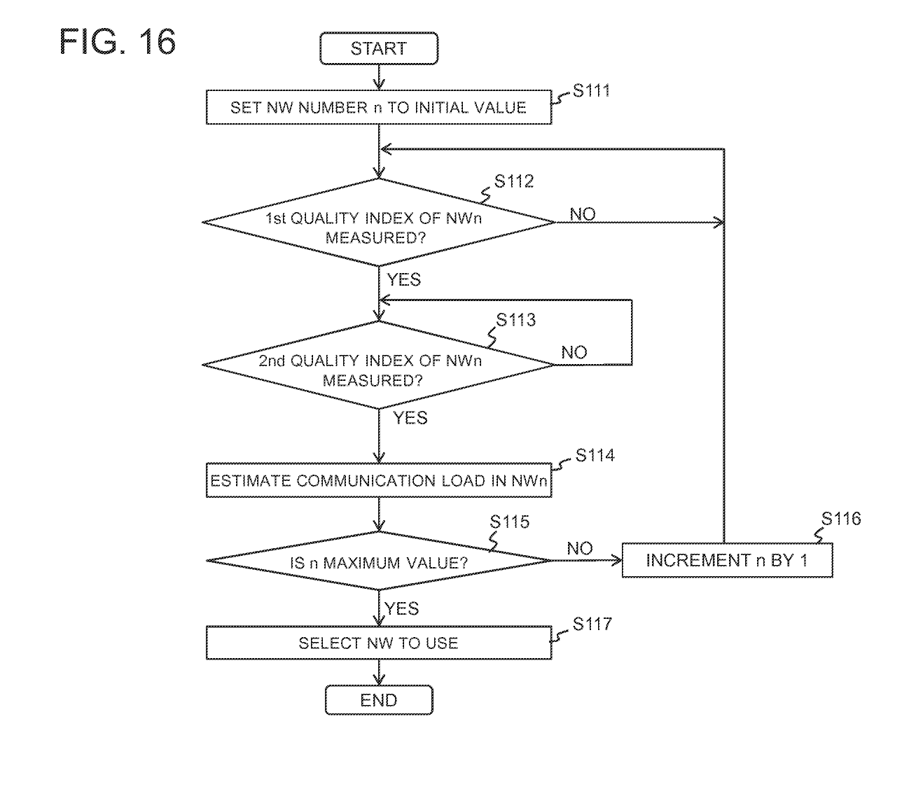

Referring to FIG. 16, the connection control section 105, after initializing the network number n (Operation S111), determines whether or not the reception data processing section 102 has measured the first quality index of a network NWn (Operation S112) and, if the first quality index has been measured (Operation S112; YES), subsequently determines whether or not the reception data processing section 102 has measured the second quality index (Operation S113). If the second quality index has been measured (Operation S113; YES), the connection control section 105 estimates the communication load of the network NWn by using the first and second index measured values of the network NWn (Operation S114).

Subsequently, if the network number n has not reached a maximum value (Operation S115; NO), n is incremented by 1 (Operation S116), and the process returns to Operation S112. In this manner, the above-described Operations S112 to S114 are repeated until n reaches the maximum value, that is, until the communication load is estimated for all of the predetermined networks. Note that the maximum value of n may be defined as the number of networks from which the wireless communication terminal 100 can receive pilot signals and the like and measure the quality indexes. In the present exemplary embodiment, the maximum value of n=3, as shown in FIG. 14. Note that any of the above-described first to fourth exemplary embodiments may be used for a method for estimating a network load.

When the estimated values of the loads on the networks NW1 to NW 3 are thus obtained, the connection control section 105 selects a network to use by using the load estimated values (Operation S117). Examples of a method for selecting a network will be described next.

### 5.3) Network Selection

The connection control section 105 can select a network with a lower load estimated value among the plurality of networks NW1 to NW3. Further, a network may be selected with consideration given to the following parameters.

Parameter 1: Estimation error of the communication load. The magnitude of an estimation error can be estimated using the magnitude of the first quality index of each cell.

Parameter 2: Priorities of the networks. For example, priorities are predetermined by network type and by operator, and a network with a higher priority is preferentially selected if the estimated values of load stand at similar levels.

Parameter 3: Reception quality of the networks. For example, a network exhibiting better reception quality is preferentially selected if the estimated load values stand at similar levels.

Specifically, the connection control section 105 selects a network with a smaller sum of the estimated load value u and an offset u_{offset}. Examples of the setting of the offset u_{offset} are as follows: the value of the offset u_{offset} is set larger for a network with a larger estimation error; the value of the offset u_{offset} is set smaller for a network intended to be preferentially connected to; the value of the offset u_{offset} is set smaller for a network exhibiting better reception quality.

### 5.4) Effects

As described above, according to the fifth exemplary embodiment of the present invention, the wireless communication terminal 100 performs control of the load estimation according to each of the above-described exemplary embodiments, whereby it is possible to select an appropriate network considering network loads. In this event, since the communication loads can be estimated without the actual connection to the networks, it is possible to suppress increases in the power consumption of the wireless communication terminal 100 and the network loads.

### 6. Sixth Exemplary Embodiment

A wireless communication terminal according to a sixth exemplary embodiment of the present invention is capable of connecting to a plurality of networks. Further, the wireless communication terminal is also capable of connecting to another network via another wireless communication terminal having mobile router functionality or tethering functionality, specifically via such another wireless communication terminal and a wireless LAN. In such a communication system as well, the wireless communication terminal according to the present exemplary embodiment includes the load estimation function according to the above-described exemplary embodiments and thus can select an appropriate network. Hereinafter, a detailed description will be given.

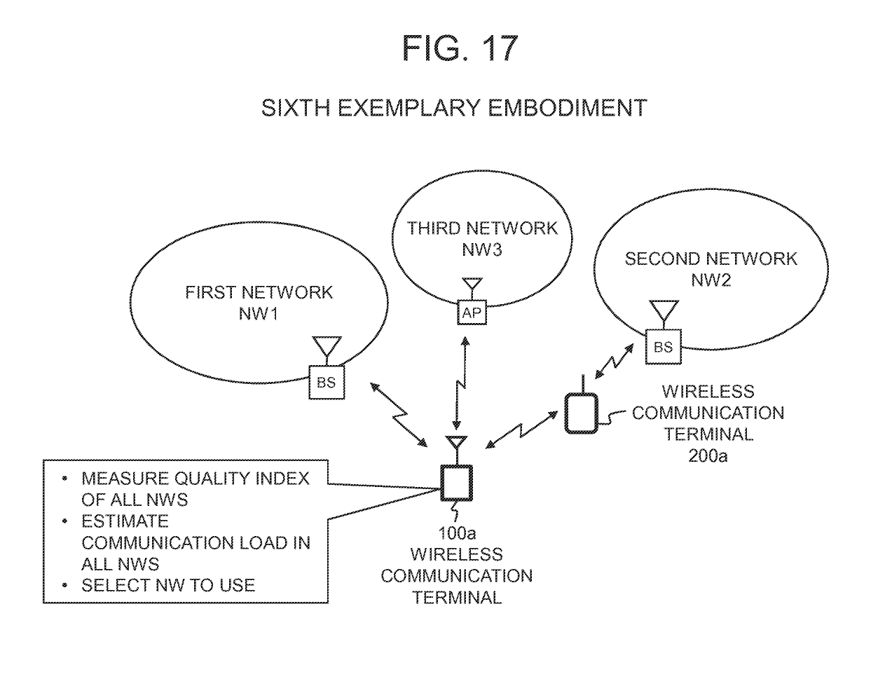

Referring to FIG. 17, a wireless communication terminal 100a according to the present exemplary embodiment is capable of connecting to networks NW1 and NW3, and another wireless communication terminal 200a is capable of connecting to a network NW2. Further, the wireless communication terminals 100a and 200a is capable of establishing a wireless connection by means of a wireless access technology such as IEEE 802.11 series-compliant Wireless LAN or IEEE 802.15 series-compliant Wireless PAN (e.g., Bluetooth™). Accordingly, the wireless communication terminal 100a can use the network NW2 via the wireless communication terminal 200a.

The configuration of the wireless communication terminal 100a is basically similar to the wireless communication terminal 100 shown in FIG. 15, but the wireless communication section 101 can connect to the networks NW1 and NW3 and also can connect to the wireless communication terminal 200a through Wireless LAN functionality. In the present exemplary embodiment, it is assumed that the reception data processing section 102 of the wireless communication terminal 100a measures the quality indexes of all the networks NW1 to NW3. Accordingly, the connection control section 105 of the wireless communication terminal 100a estimates the communication load of each network by following the operation flow shown in FIG. 16 and thus can select an appropriate network by using the communication load estimated values.

Note that, as another configuration, it is also possible that the wireless communication terminal 200a measures the quality indexes of the networks NW1 to NW 3 and selects a network by using respective load estimated values of the networks. In this case, the wireless communication terminal 100a connects to the wireless communication terminal 200a via a wireless LAN and connects to a network selected by the wireless communication terminal 200a via the wireless communication terminal 200a.

As described above, according to the wireless communication terminal 100a according to the sixth exemplary embodiment of the present invention, in addition to effects similar to those of the above-described fifth exemplary embodiment, it is also possible to use a network via the other wireless communication terminal 200a through similar communication load estimation.

### 7. Seventh Exemplary Embodiment

In the above-described sixth exemplary embodiment, a wireless communication terminal measures the quality indexes of all networks and estimates communication loads. In a seventh exemplary embodiment of the present invention, each wireless communication terminal measures the quality indexes of a network it can connect to, estimates a communication load, and is notified of communication loads estimated by other wireless communication terminals. In such a communication system, a wireless communication terminal according to the present exemplary embodiment can obtain communication load estimated values of all networks similarly to the load estimation functions according to the above-described exemplary embodiments and therefore can select an appropriate network. Hereinafter, a detailed description will be given.

### 7.1) System Architecture

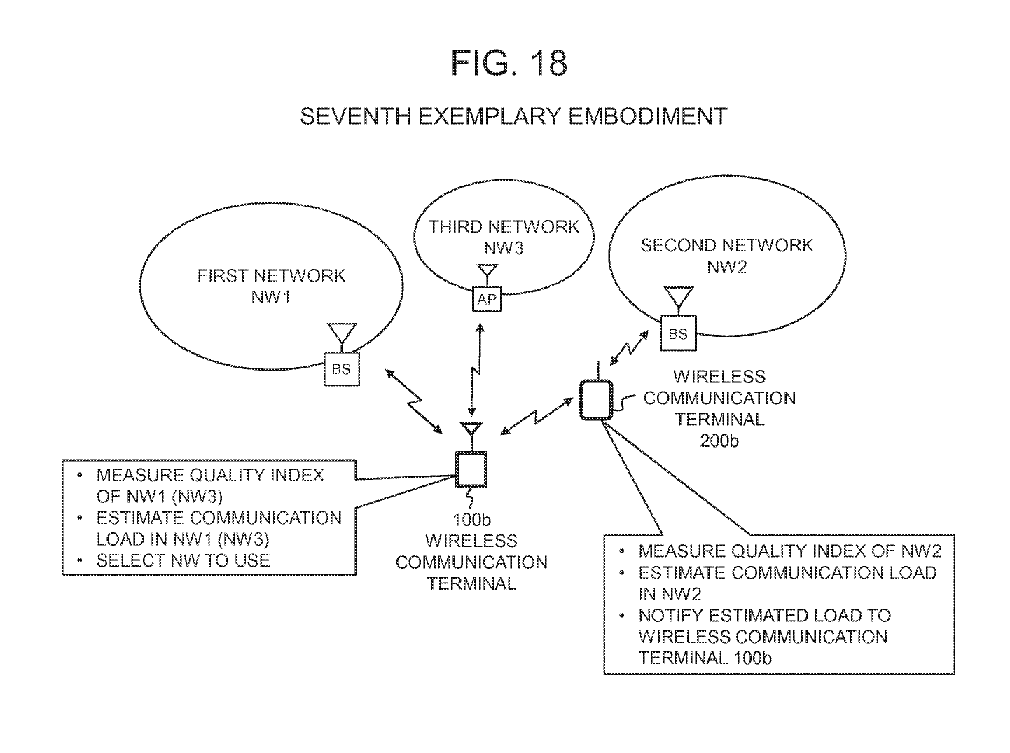

Referring to FIG. 18, a wireless communication terminal 100b according to the present exemplary embodiment is capable of connecting to networks NW1 and NW3, and another wireless communication terminal 200b having mobile router functionality is capable of connecting to a network NW2. Further, the wireless communication terminals 100b and 200b are capable of establishing a wireless connection by means of Wireless LAN as described above, so that the wireless communication terminal 100b can use the network NW2 via the wireless communication terminal 200b.

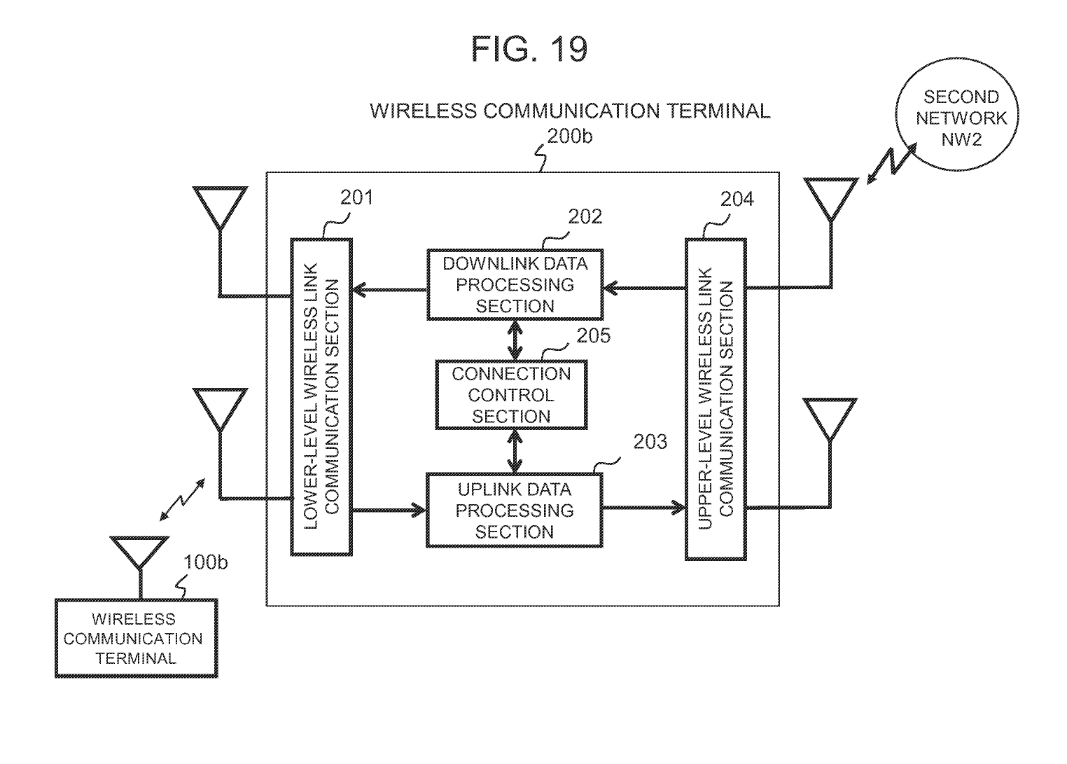

Referring to FIG. 19, the wireless communication terminal 200b is, for example, a mobile router such as a smartphone having tethering functionality or WiFi router and performs control of transfer of sent and received data between the wireless communication terminal 100b and the network NW2. A lower-level wireless link communication section 201 wirelessly connects to the wireless communication terminal 100b by means of a wireless access scheme such as Wireless LAN or Wireless PAN mentioned above, sends transmission data from a downlink data processing section 202 to the wireless communication terminal 100b, and outputs data received from the wireless communication terminal 100b to an uplink data processing section 203. A higher-level wireless link communication section 204 wirelessly connects to a base station in the network NW2 by means of the same wireless access scheme as in case of the wireless communication terminal 100b mentioned above or a different wireless access scheme and thus can communicate with the network NW2.

As in the communication load estimation according to the first to fourth exemplary embodiments, the downlink data processing section 202 measures the quality indexes of the network NW2, and a connection control section 205 estimates the communication load of the network NW2 by using the measured values. Moreover, the connection control section 205 can notify the communication load estimated value of the network NW2 to the wireless communication terminal 100b via the lower-level wireless link communication section 201.

### 7.2) Operations

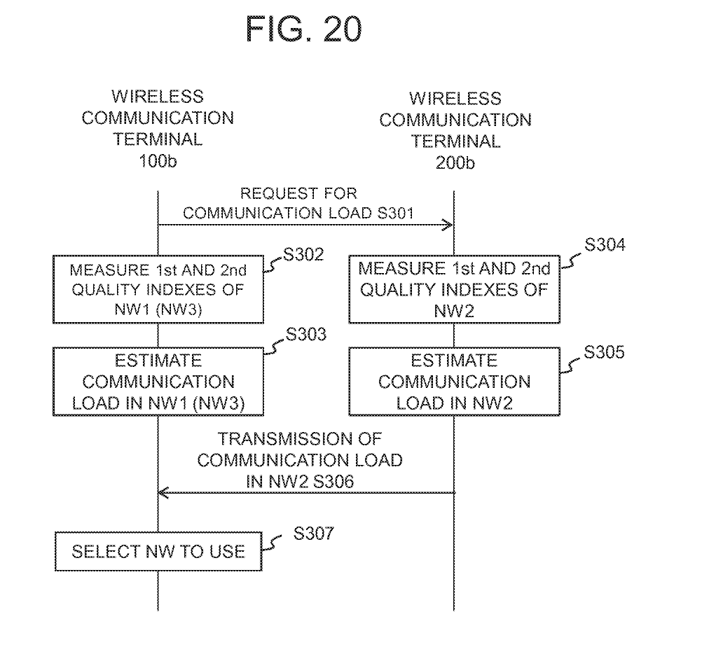

Referring to FIG. 20, a connection control section 105 of the wireless communication terminal 100b according to the present exemplary embodiment, when starting network selection, sends a request for a communication load to the wireless communication terminal 200b (Operation S301). Subsequently, a reception data processing section 102 measures the first and second quality indexes of the networks NW1 and NW3 as in the above-described first to fourth exemplary embodiments (Operation S302). The connection control section 105 estimates the communication loads on the networks NW1 and NW3 by using the measured values (Operation S303).

On the other hand, the connection control section 205 of the wireless communication terminal 200b, when receiving the request for a communication load via the uplink data processing section 203, controls the downlink data processing section 202, so that the downlink data processing section 202 measures the first and second quality indexes of the network NW2 as in the above-described first to fourth exemplary embodiments (Operation S304). The connection control section 205 estimates the communication load of the network NW2 by using the measured values (Operation S305) and sends the load estimated value of the network NW2 to the wireless communication terminal 100b via the downlink data processing section 202 (Operation S306).

The connection control section 105 of the wireless communication terminal 100b, when receiving the communication load estimated value of the network NW2 from the wireless communication terminal 200b, uses it along with the communication load estimated values of the networks NW1 and NW3 estimated by its own terminal to select an appropriate network as described above in the fifth exemplary embodiment (Operation S307).

### 7.3) Effects

As described above, according to the seventh exemplary embodiment of the present invention, the wireless communication terminal 100b and the wireless communication terminal 200b operating as a mobile router individually estimate the communication loads on the respective networks they can connect to. The wireless communication terminal 100b then receives the communication load estimated value estimated by the wireless communication terminal 200b and thus can perform network selection by using the communication load estimated values of all the networks. The wireless communication terminals 100b and 200b share the processing for network load estimation, whereby a processing load of each wireless communication terminal is lightened, so that the power consumption thereof can be reduced.

Note that it is also possible that the wireless communication terminal 100b notifies the wireless communication terminal 200b of the load estimated values of the networks NW1 and NW3, and the wireless communication terminal 200b selects a network by using the load of the network NW2 estimated by itself and the acquired load estimated values of the networks NW1 and NW3.

### 8. Eighth Exemplary Embodiment

In the above-described seventh exemplary embodiment, a wireless communication terminal and another wireless communication terminal share the processing for network load estimation. In an eighth exemplary embodiment of the present invention, the other wireless communication terminal only performs quality index measurement and notifies the measured values to the wireless communication terminal. In such a system as well, a wireless communication terminal according to the present exemplary embodiment can acquire communication load estimated values of all networks similarly to the load estimation functions according to the above-described exemplary embodiments and therefore can select an appropriate network.

### 8.1) System Architecture

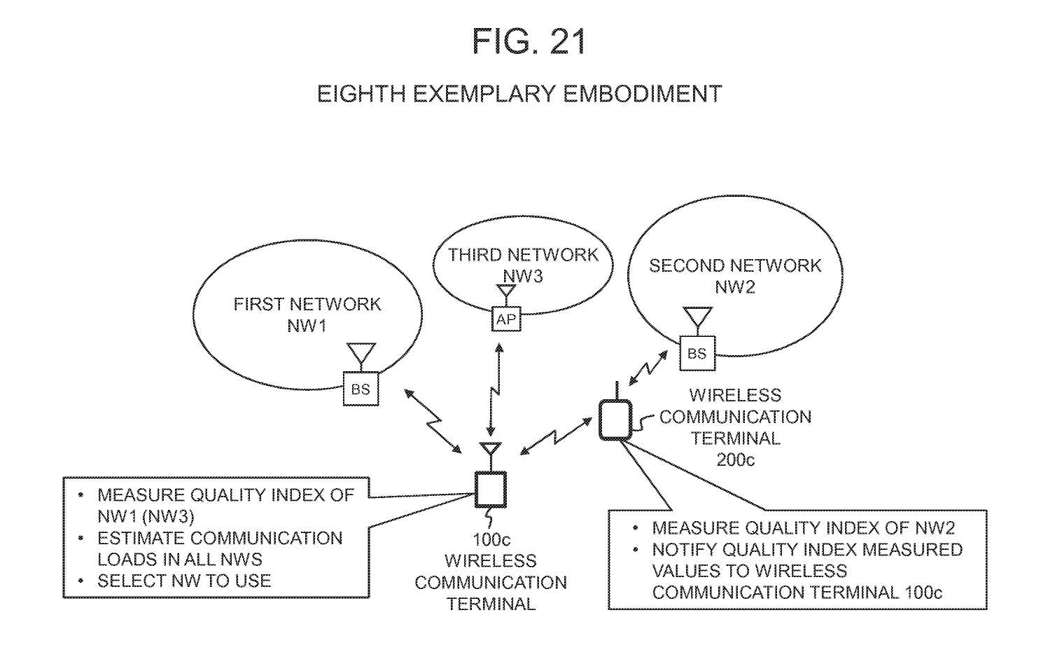

Referring to FIG. 21, a wireless communication terminal 100c according to the present exemplary embodiment is capable of connecting to networks NW1 and NW3, and another wireless communication terminal 200c having mobile router functionality is capable of connecting to a network NW2. Further, the wireless communication terminals 100c and 200c is capable of establishing a wireless connection by means of Wireless LAN as described above, so that the wireless communication terminal 100c can use the network NW2 via the wireless communication terminal 200c.

### 8.2) System Operations

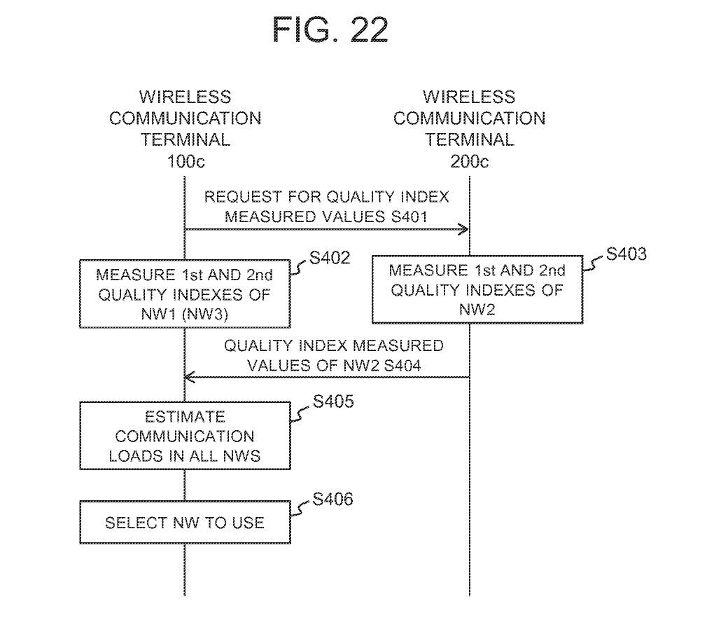

Referring to FIG. 22, a connection control section 105 of the wireless communication terminal 100c according to the present exemplary embodiment, when starting network selection, sends a request for quality index measured values to the wireless communication terminal 200c (Operation S401). Subsequently, a reception data processing section 102 measures the first and second quality indexes of the networks NW1 and NW3 as in the above-described first to fourth exemplary embodiments (Operation S402).

On the other hand, a connection control section 205 of the wireless communication terminal 200c, when receiving the request for quality index measured values via an uplink data processing section 203, controls a downlink data processing section 202, so that the downlink data processing section 202 measures the first and second quality indexes of the network NW2 as in the above-described first to fourth exemplary embodiments (Operation S403). The connection control section 205 sends the quality index measured values of the network NW2 to the wireless communication terminal 100c via the downlink data processing section 202 (Operation S404).

The connection control section 105 of the wireless communication terminal 100c estimates the communication loads on all the networks by using the quality index measured values of the network NW2 received from the wireless communication terminal 200c and the quality index measured values of the networks NW1 and NW3 measured by its own terminal (Operation S405) and uses these communication load estimated values to select an appropriate network as described above in the fifth exemplary embodiment (Operation S406).

### 8.3) Effects

As described above, according to the eighth exemplary embodiment of the present invention, the wireless communication terminal 100c and the wireless communication terminal 200c operating as a mobile router individually measure the quality indexes of the respective networks they can connect to. The wireless communication terminal 100c then receives the quality index measured values measured by the wireless communication terminal 200c and thus can estimate the communication load of each network by using the quality index measured values of all the networks and perform network selection by using these load estimated values. The wireless communication terminals 100c and 200c share the processing for network quality index measurement, and the wireless communication terminal 100c performs the processing for network load estimation, whereby a processing load of each wireless communication terminal is lightened, so that the power consumption, particularly of the wireless terminal 200c, can be reduced.

Note that it is also possible that the wireless communication terminal 100c notifies the wireless communication terminal 200c of the quality index measured values of the networks NW1 and NW3, and the wireless communication terminal 200c estimates the communication load of each network by using the quality indexes of the network NW2 measured by itself and the acquired quality index measure values of the networks NW1 and NW3 and then selects a network by using these load estimated values.

### 9. Ninth Exemplary Embodiment

In the above-described sixth to eighth exemplary embodiments, the communication load of each network is estimated based on the first and second quality indexes of each network, and a network to connect to is selected. According to a ninth exemplary embodiment, a network to connect to can be selected by using simplified radio quality information on one of wireless communication terminals, as well as reception quality and a network communication load, where the reception quality is measured and the network communication load is estimated by the other wireless communication terminal.

### 9.1) System Architecture

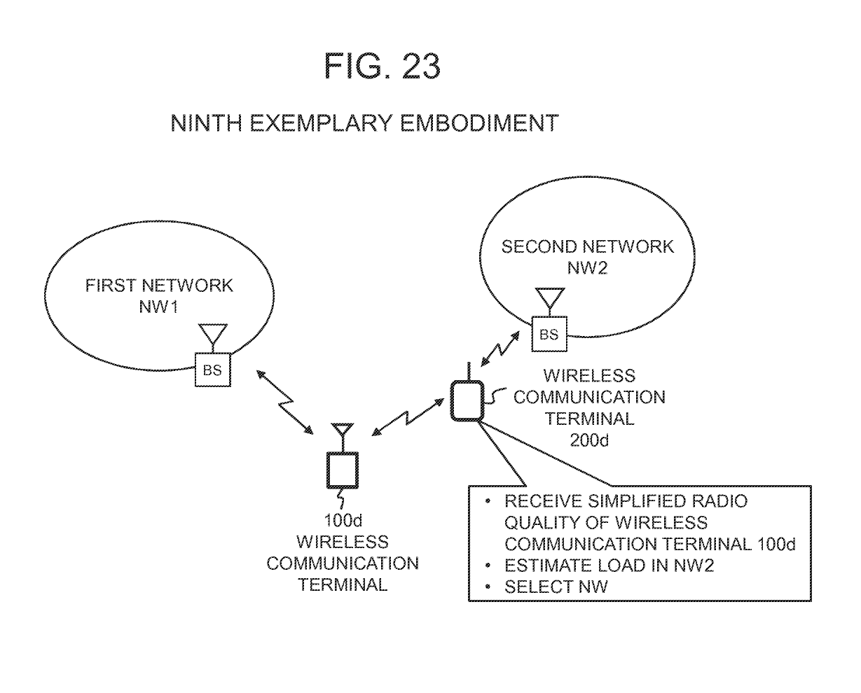

Referring to FIG. 23, it is assumed that a wireless communication terminal 100d according to the present exemplary embodiment is capable of connecting to a network NW1, and that another wireless communication terminal 200d having mobile router functionality is capable of connecting to a network NW2. The wireless communication terminal 100d may be capable of further connecting to another network (third network) as describe already. Moreover, the wireless communication terminals 100d and 200d is capable of establishing a wireless connection by means of Wireless LAN as described already, so that the wireless communication terminal 100d can use the wireless NW2 via the wireless communication terminal 200d. Note that the basic configurations of the wireless communication terminals 100d and 200d are similar to the block diagrams shown in FIGS. 15 and 19, respectively, and therefore a description thereof will be given by using the same reference signs. However, the functions of the connection control sections 105 and 205 in the present exemplary embodiment are different from those of the above described exemplary embodiments, which will be described below.

### 9.2) System Operations

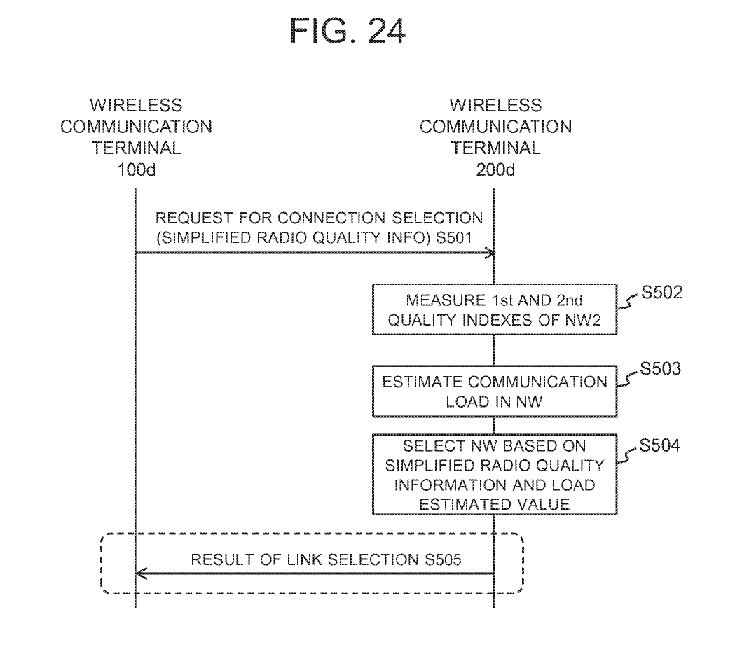

Referring to FIG. 24, the connection control section 105 of the wireless communication terminal 100d according to the present exemplary embodiment, when starting network selection, sends a request for connection selection including simplified radio quality information on its own terminal to the wireless communication terminal 200d (Operation S501). The simplified radio quality information is information indicating simplified radio quality, for which, for example, the number of antenna bars of the own terminal can be used. When receiving the request for connection selection, the connection control section 205 of the wireless communication terminal 200d measures the first and second quality indexes of the network NW2 as in the above-described first to fourth exemplary embodiments (Operation S502) and estimates the communication load of the network NW2 by using these measured values (Operation S503).

Subsequently, the connection control section 205 of the wireless communication terminal 200d selects an appropriate network based on the simplified radio quality information received from the wireless communication terminal 100d and the communication load of the network NW2 estimated by its own terminal, in accordance with selection criteria, which will be described later (Operation S504). In this event, the connection control section 205 may notify a result of the network selection to the wireless communication terminal 100d (Operation S505).

Alternatively, if the wireless communication terminal 100d is set such as to preferentially select a link on the wireless communication terminal 200d side, it is also possible to control the wireless communication terminal 100d's network selection by the wireless communication terminal 200d turning on/off the Wireless LAN function between the wireless communication terminal 100d and itself, without notifying a result of the network selection.

### 9.3) Criteria for Network Selection

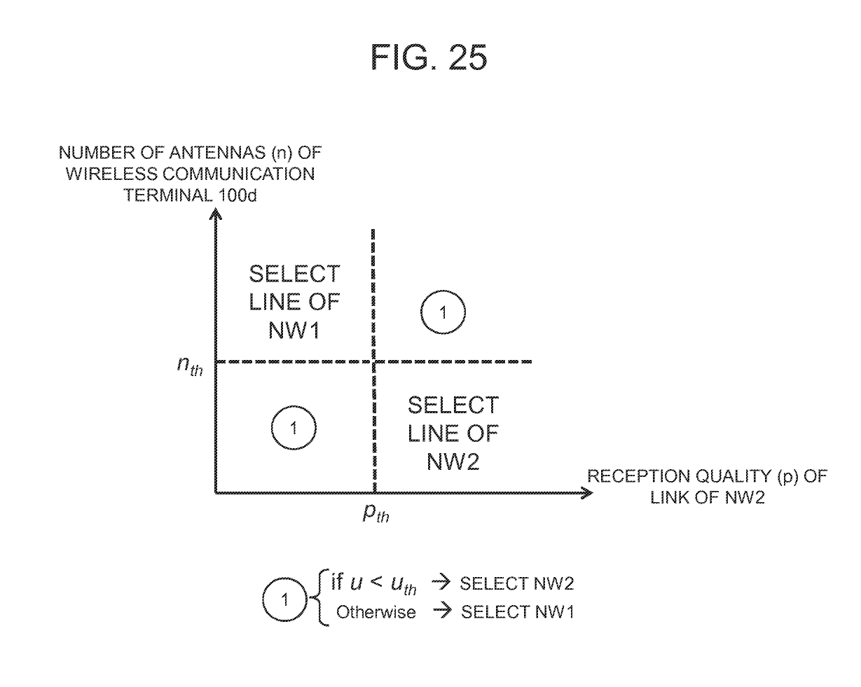

Referring to FIG. 25, according to the present exemplary embodiment, a network is selected, taking into consideration not only network load estimated value u but also reception quality p of network line and the number of antennas n of the wireless communication terminal 100d. Specifically, the network NW2 is selected when the reception quality p of the network NW2 is not lower than a predetermined value pₜₕ and the number of antennas n of the wireless communication terminal 100d is smaller than a predetermined value nₜₕ, but the network NW1 is selected when the reception quality p of the network NW2 is lower than the predetermined value pₜₕ and the number of antennas n of the wireless communication terminal 100d is not smaller than the predetermined value nₜₕ. In other cases (indicated by circled 1 in FIG. 25), the network NW2 is selected when the load estimated value of the network NW2 is smaller than a predetermined value uₜₕ, but otherwise the network NW1 is selected. Note that for the radio quality p, the above-described first or second quality index can be used.

### 9.4) Operations of Wireless Communication Terminal 200d

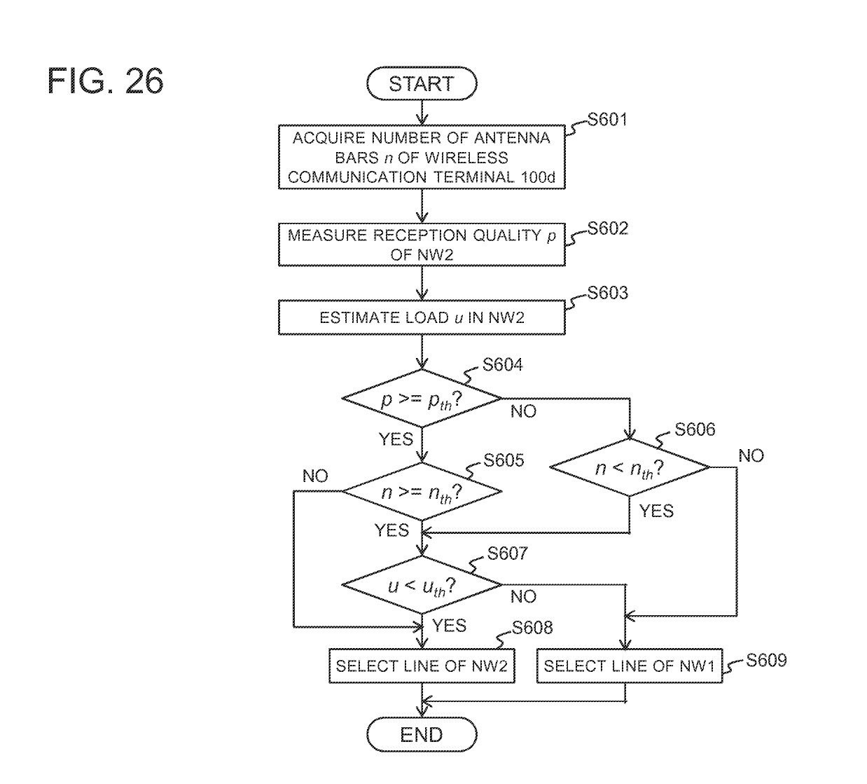

Referring to FIG. 26, the connection control section 205 of the wireless communication terminal 200d acquires the number of antennas n from the wireless communication terminal 100d as its simplified radio quality information (Operation S601). Subsequently, the connection control section 205 measures the reception quality p of the network NW2 (Operation S602) and estimates the load u on the network NW2 through any method described already (Operation S603).

Subsequently, the connection control section 205 determines whether or not the reception quality p of the network NW2 is equal to or higher than the predetermined value pₜₕ (Operation S604) and, if p≧pₜₕ (Operation S604; YES), further determines whether or not the number of antennas n of the wireless communication terminal 100d is equal to or larger than the predetermined value nₜₕ (Operation S605). Moreover, if p<pₜₕ (Operation S604; NO), the connection control section 205 determines whether or not the number of antennas n of the wireless communication terminal 100d is smaller than the predetermined value nₜₕ (Operation S606).

When p≧pₜₕ (Operation S604; YES) and n nₜₕ (Operation S605; YES), or when p<pₜₕ (Operation S604; NO) and n<nₜₕ (Operation S606; YES), then the connection control section 205 determines whether or not the load estimated value u of the network NW2 is smaller than the predetermined value uₜₕ (Operation S607). The connection control section 205 selects the network NW2 (Operation S608) when u<uₜₕ (Operation S607; YES) but selects the network NW1 (Operation S609) when u≧uₜₕ (Operation S607; NO).

Moreover, the connection control section 205 selects the network NW2 (Operation S608) when p≧pₜₕ (Operation S604; YES) and n<nₜₕ (Operation S605; NO). The connection control section 205 selects the network NW1 (Operation S609) when p<pₜₕ (Operation S604; NO) and n nₜₕ (Operation S605; NO).

Note that although the wireless communication terminal 200d selects a network for the wireless communication terminal 100d to connect to by using the network load estimated by itself and the simplified radio quality information acquired from the wireless communication terminal 100d in the present exemplary embodiment, it is also possible that the wireless communication terminal 100d selects a network by using a network load estimated by itself and simplified radio quality information acquired from the wireless communication terminal 200d.

### 9.5) Effects

As described above, according to the ninth exemplary embodiment of the present invention, a network is selected based on simplified radio quality information on one of wireless communication terminals and based on reception quality measured and a network communication load estimated by the other wireless communication terminal. Accordingly, it is possible to select an appropriate network even when acquirable radio quality information is limited. Further, network selection control is more simplified, and the amount of information notified between wireless communication terminals can also be reduced.

### 10. Example of Wireless Communication Terminal Configuration

Control operations by any wireless communication terminal (10, 10a, 10b, 100, 100a, 100b, 100c, 100d, 200a, 200b, 200c, 200d) according to each exemplary embodiment described above can also be implemented by executing programs on a processor (computer) provided to each wireless communication terminal. Hereinafter, a brief description will be given of an example of implementation by means of software.

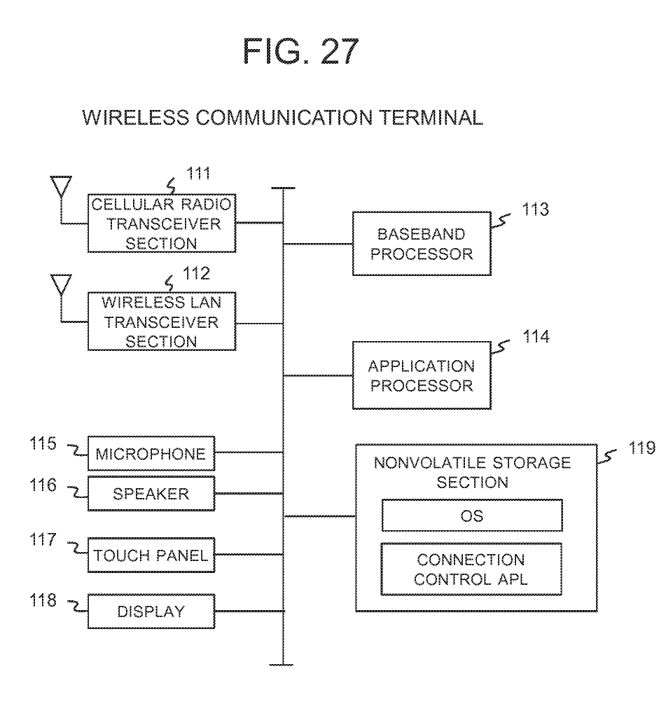

Referring to FIG. 27, a wireless communication terminal includes a cellular radio transceiver section 111, a wireless LAN transceiver section 112, and a baseband processor 113 as the wireless communication section 101 and reception data processing section 102 in FIG. 15, or as the lower-order wireless link communication section 201, downlink data processing section 202, and higher-order wireless link communication section 204 in FIG. 19. Moreover, the wireless communication terminal also includes a microphone 115, a speaker 116, a touch panel 117, and a display 118 as specific examples of input and output devices. An application processor 114 implements the various functions of the wireless communication terminal 10 by executing a system software program (OS (Operating System)) and programs for a link control application and other various applications (e.g., web browser and mailer) read from a nonvolatile storage section 119.

The nonvolatile storage section 119 is, for example, a flash memory, hard disk drive and the like. The application processor 114 executes the link control application, whereby the functions of the connection control section 105 or 205 described above are implemented. Note that the connection control section 105 or 205 may be implemented by a semiconductor device including an ASIC (Application Specific Integrated Circuit).

The above-mentioned various programs for the wireless communication terminal can be stored and provided to a computer by using a various types of non-transitory computer readable media. The non-transitory computer readable media include various types of tangible storage media. Example of the non-transitory computer readable media include magnetic storage media (e.g., flexible disk, magnetic tape, hard disk drive), magneto-optical storage media (e.g., magneto-optical disk), CD-ROM (Read Only Memory), CD-R, CD-R/W, and semiconductor memories (e.g., mask ROM, PROM (Programmable ROM), EPROM (Erasable PROM), flash ROM, RAM (Random Access Memory)). Moreover, the programs may also be provided by using various types of transitory computer readable media. Examples of the transitory computer readable media include electric signals, optical signals, and electromagnetic waves. The transitory computer readable media can provide the programs to a computer through wired communication links such as cable and optical fiber or wireless communication links.

### 11. Additional Statements

Part or all of the above-described exemplary embodiments also can be stated as in, but is not limited to, the following additional statements.

### Additional Statement 1

A method for estimating a communication load of a network,

characterized in that a wireless communication terminal estimates a communication load of a network by using a first quality index that does not depend on a network communication load and a second quality index that depends on a network communication load.

### Additional Statement 2

The method for estimating a network communication load according to additional statement 1, characterized in that the communication load is estimated by using a ratio between the first quality index and the second quality index.

### Additional Statement 3

The method for estimating a network communication load according to additional statement 2, characterized in that the first quality index is RSRP (Reference Signal Received Power) and the second quality index is RSRQ (Reference Signal Received Quality).

### Additional Statement 4

The method for estimating a network communication load according to additional statement 3, characterized in that the network includes a plurality of cells having a predetermined resource block structure, wherein, assuming that the communication load is a resource use rate u of the network, the resource use rate u is estimated using a following equation:

$$\begin{matrix}u = \frac{1}{5} ( \frac{\frac{{p}_{l}}{{q}_{l}} - Noise}{2 {\sum }_{k = 1}^{K} {p}_{k}} - 1 ) & [ Math . 11 ]\end{matrix}$$

where k is a cell number, K is a number of cells, p is RSRP, q is RSRQ, I is an arbitrary natural number not larger than K, which specifies a cell, and Noise is noise power per resource block.

### Additional Statement 5

The method for estimating a network communication load according to additional statement 2, characterized in that the first quality index is RSCP (Reference Signal Code Power) and the second quality index is Ec/No (Energy per chip/Noise).

### Additional Statement 6

The method for estimating a network communication load according to additional statement 5, characterized in that the network includes a plurality of cells based on a system in which a common pilot channel signal and user transmitted signals are code-division-multiplexed, wherein, assuming that the communication load is an average number of concurrently multiplexed users u, the average number of concurrently multiplexed users u is estimated using a following equation:

$$u = \frac{\frac{{p}_{l}}{{E}_{c} / {N}_{o} ( l )} - Noise}{{\sum }_{k = 1}^{K} {p}_{k}} - 1 \qquad [ Math . 12 ]$$

where k is a cell number, K is a number of cells, p is RSCP, Noise is noise power within a band, Ec/No(I) is Ec/No of an l-th cell, and I is an arbitrary natural number not larger than K, which specifies a cell.

### Additional Statement 7

The method for estimating a network communication load according to any one of additional statements 1 to 6, characterized in that the network includes a plurality of cells, wherein cells to be used for estimation of the communication load are limited depending on magnitudes of measured values of at least one quality index of the first and second quality indexes.

### Additional Statement 8

The method for estimating a network communication load according to additional statement 7, characterized in that cells to be used for estimation of the communication load are limited to those cells with the measured values of the quality index larger than a predetermined value.

### Additional Statement 9

The method for estimating a network communication load according to additional statement 7, characterized in that cells to be used for estimation of the communication load are limited to a predetermined number of top cells in descending order of the measured value of the quality index.

### Additional Statement 10

The method for estimating a network communication load according to additional statement 7, characterized in that cells to be used for estimation of the communication load are limited to those cells with the measured values of the quality index, differences of which from the largest one are smaller than a predetermined value.

### Additional Statement 11

The method for estimating a network communication load according to any one of additional statements 1 to 10, characterized in that measured values are obtained by measuring at least one of the first and second quality indexes more than once at different times, and the communication load of the network is estimated by using statistical values of these measured values.

### Additional Statement 12

The method for estimating a network communication load according to additional statement 11, characterized in that a statistical setting value for calculating the statistical values is determined based on a magnitude of variation of the measured values over time.

### Additional Statement 13

The method for estimating a network communication load according to additional statement 12, characterized in that the statistical setting value is a number of the measured values and/or a weighing coefficient on the measured values.

### Additional Statement 14

The method for estimating a network communication load according to any one of additional statements 1 to 10, characterized by comprising:

every time the first and second quality indexes are measured more than once at different times, estimating a first communication load by using respective measured values thereof; and

determining the communication load of the network based on a plurality of the first communication loads.

### Additional Statement 15

The method for estimating a network communication load according to additional statement 14, characterized in that statistical values of the plurality of first communication loads are calculated as the communication loads on the network.

### Additional Statement 16

The method for estimating a network communication load according to additional statement 15, characterized in that a statistical setting value for calculating the statistical values is determined based on a magnitude of variation of the plurality of first communication loads over time.

### Additional Statement 17

The method for estimating a network communication load according to additional statement 15, characterized in that the statistical setting value is a number of the first communication loads and/or a weighting coefficient on the first communication loads.

### Additional Statement 18

The method for estimating a network communication load according to additional statement 14, characterized in that one of the plurality of first communication loads is selected as the communication load of the network in accordance with a predetermined criterion.

### Additional Statement 19

The method for estimating a network communication load according to additional statement 18, characterized in that a largest, smallest, or median value of the plurality of first communication loads is selected in accordance with the predetermined criterion.

### Additional Statement 20

The method for estimating a network communication load according to any one of additional statements 1 to 19, characterized in that the wireless communication terminal estimates communication loads on a plurality of networks.

### Additional Statement 21

The method for estimating a network communication load according to additional statement 20, characterized in that the wireless communication terminal measures the first and second quality indexes of each of the plurality of networks and, based on measured values thereof, estimates the communication loads on the networks.

### Additional Statement 22

The method for estimating a network communication load according to any one of additional statements 1 to 19,

characterized in that the wireless communication terminal measures the first and second quality indexes of at least one first network and, based on measured values thereof, estimates a communication load of the first network,

another wireless communication terminal wirelessly connected to the wireless communication terminal measures the first and second quality indexes of at least one second network and, based on measured values thereof, estimates a communication load of the second network, and

the wireless communication terminal receives the communication load of the second network from the other wireless communication terminal.

### Additional Statement 23

The method for estimating a network communication load according to additional statement 20,

characterized in that the wireless communication terminal measures the first and second quality indexes of at least one first network,

another wireless communication terminal wirelessly connected to the wireless communication terminal measures the first and second quality indexes of at least one second network, and

the wireless communication terminal receives measured values of the second network from the other wireless communication terminal and thus, based on measured values of the first network and the measured values of the second network, estimates the communication loads on the plurality of networks.

### Additional Statement 24

A wireless communication terminal that can connect to at least one network, characterized by comprising:

load estimation means for estimating a communication load of the network by using a first quality index that does not depend on a network communication load and a second quality index that depends on a network communication load.

### Additional Statement 25

The wireless communication terminal according to additional statement 24, characterized in that the load estimation means estimates the communication load by using a ratio between the first quality index and the second quality index.

### Additional Statement 26

The wireless communication terminal according to additional statement 25, characterized in that the first quality index is RSRP (Reference Signal Received Power) and the second quality index is RSRQ (Reference Signal Received Quality).

### Additional Statement 27

The wireless communication terminal according to additional statement 26, characterized in that the network includes a plurality of cells having a predetermined resource block structure, wherein, assuming that the communication load is a resource use rate u of the network, the load estimation means estimates the resource use rate u by using a following equation:

$$u = \frac{1}{5} ( \frac{\frac{{p}_{l}}{{q}_{l}} - Noise}{2 {\sum }_{k = 1}^{K} {p}_{k}} - 1 ) \qquad [ Math . 13 ]$$

where k is a cell number, K is a number of cells, p is RSRP, q is RSRQ, I is an arbitrary natural number not larger than K, which specifies a cell, and Noise is noise power per resource block.

### Additional Statement 28

The wireless communication terminal according to additional statement 25, characterized in that the first quality index is RSCP (Reference Signal Code Power) and the second quality index is Ec/No (Energy per chip/Noise).

### Additional Statement 29

The wireless communication terminal according to additional statement 28, characterized in that the network includes a plurality of cells based on a system in which a common pilot channel signal and user transmitted signals are code-division-multiplexed, wherein, assuming that the communication load is an average number of concurrently multiplexed users u, the load estimation means estimates the average number of concurrently multiplexed users u by using a following equation:

$$u = \frac{\frac{{p}_{l}}{{E}_{c} / {N}_{o} ( l )} - Noise}{{\sum }_{k = 1}^{K} {p}_{k}} - 1 \qquad [ Math . 14 ]$$

where k is a cell number, K is a number of cells, p is RSCP, Noise is noise power within a band, Ec/No(I) is Ec/No of an l-th cell, and I is an arbitrary natural number not larger than K, which specifies a cell.

### Additional Statement 30

The wireless communication terminal according to any one of additional statements 24 to 29, characterized in that the network includes a plurality of cells, wherein the load estimation means limits cells to be used for estimation of the communication load, depending on magnitudes of measured values of at least one quality index of the first and second quality indexes.

### Additional Statement 31

The wireless communication terminal according to additional statement 30, characterized in that the load estimation means limits cells to be used for estimation of the communication load to those cells with the measured values of the quality index larger than a predetermined value.

### Additional Statement 32

The wireless communication terminal according to additional statement 30, characterized in that the load estimation means limits cells to be used for estimation of the communication load to a predetermined number of top cells in descending order of the measured value of the quality index.

### Additional Statement 33

The wireless communication terminal according to additional statement 30, characterized in that the load estimation means limits cells to be used for estimation of the communication load to those cells with the measured values of the quality index, differences of which from the largest one are smaller than a predetermined value.

### Additional Statement 34

The wireless communication terminal according to any one of additional statements 24 to 33, characterized in that the load estimation means obtains measured values by measuring at least one of the first and second quality indexes more than once at different times, and estimates the communication load of the network by using statistical values of these measured values.

### Additional Statement 35

The wireless communication terminal according to additional statement 34, characterized in that the load estimation means determines a statistical setting value for calculating the statistical values, based on a magnitude of variation of the measured values over time.

### Additional Statement 36

The wireless communication terminal according to additional statement 35, characterized in that the statistical setting value is a number of the measured values and/or a weighing coefficient on the measured values.

### Additional Statement 37

The wireless communication terminal according to any one of additional statements 24 to 33, characterized in that every time the load estimation means measures the first and second quality indexes more than once at different times, the load estimation means estimates a first communication load by using respective measured values thereof and, based on a plurality of the first communication loads, determines the communication load of the network.

### Additional Statement 38

The wireless communication terminal according to additional statement 37, characterized in that the load estimation means calculates statistical values of the plurality of first communication loads as the communication loads on the network.

### Additional Statement 39

The wireless communication terminal according to additional statement 38, characterized in that the load estimation means determines a statistical setting value for calculating the statistical values, based on a magnitude of variation of the plurality of first communication loads over time.

### Additional Statement 40

The wireless communication terminal according to additional statement 39, characterized in that the statistical setting value is a number of the first communication loads and/or a weighting coefficient on the first communication loads.

### Additional Statement 41

The wireless communication terminal according to additional statement 37, characterized in that the load estimation means selects one of the plurality of first communication loads as the communication load of the network in accordance with a predetermined criterion.

### Additional Statement 42

The wireless communication terminal according to additional statement 41, characterized in that a largest, smallest, or median value of the plurality of first communication loads is selected in accordance with the predetermined criterion.

### Additional Statement 43

The wireless communication terminal according to any one of additional statements 24 to 42, characterized by further comprising:

network selection means for selecting a network to connect to among a plurality of networks,

wherein the load estimation means estimates a communication load of at least one network, and the network selection means selects the network by using at least the estimated communication load.

### Additional Statement 44

The wireless communication terminal according to additional statement 43, characterized in that the network selection means selects the network, depending on the estimated communication load and accuracy of the estimation.

### Additional Statement 46

The wireless communication terminal according to additional statement 43, characterized in that the network selection means selects the network, depending on the estimated communication load and priorities of the networks.

### Additional Statement 47

The wireless communication terminal according to additional statement 43, characterized in that the network selection means selects the network, depending on the estimated communication load and reception quality of the networks.

### Additional Statement 48

The wireless communication terminal according to any one of additional statements 43 to 47, characterized by further comprising:

quality index measurement means for measuring the first and second quality indexes by receiving signals from the networks individually,

wherein the load estimation means estimates the communication load of the at least one network, based on measured values of the first and second quality indexes of the at least one network.

### Additional Statement 49

The wireless communication terminal according to additional statement 48,

characterized in that the quality index measurement means measures the first and second quality indexes of at least one first network, and based on measured values thereof the load estimation means estimates a communication load of the first network, and

upon receiving a communication load of at least one second network from another wireless communication terminal wirelessly connected to the wireless communication terminal, the network selection means selects the network by using the communication load of the first network and the communication load of the second network.

### Additional Statement 50

The wireless communication terminal according to additional statement 48,

characterized in that the quality index measurement means measures the first and second quality indexes of at least one first network,

upon receiving measured values obtained by another wireless communication terminal wirelessly connected to the wireless communication terminal measuring the first and second quality indexes of at least one second network, the load estimation means estimates communication loads on the plurality of networks based on measured values of the first network and the measured values of the second network, and

the network selection means selects the network to connect to by using the communication loads on the plurality of networks.

### Additional Statement 51

A communication system comprising at least one network and a wireless communication terminal that can connect to the network,

characterized in that the wireless communication terminal estimates a communication load of the network by using a first quality index that does not depend on a network communication load and a second quality index that depends on a network communication load.

### Additional Statement 52

The communication system according to additional statement 51, characterized in that the wireless communication terminal estimates the communication load by using a ratio between the first quality index and the second quality index.

### Additional Statement 53

The communication system according to additional statement 52, characterized in that the first quality index is RSRP (Reference Signal Received Power) and the second quality index is RSRQ (Reference Signal Received Quality).

### Additional Statement 54

The communication system according to additional statement 53, characterized in that the network includes a plurality of cells having a predetermined resource block structure, wherein, assuming that the communication load is a resource use rate u of the network, the wireless communication terminal estimates the resource use rate u by using a following equation:

$$u = \frac{1}{5} ( \frac{\frac{{p}_{l}}{{q}_{l}} - Noise}{2 {\sum }_{k = 1}^{K} {p}_{k}} - 1 ) \qquad [ Math . 15 ]$$

where k is a cell number, K is a number of cells, p is RSRP, q is RSRQ, I is an arbitrary natural number not larger than K, which specifies a cell, and Noise is noise power per resource block.

### Additional Statement 55

The communication system according to additional statement 52, characterized in that the first quality index is RSCP (Reference Signal Code Power) and the second quality index is Ec/No (Energy per chip/Noise).

### Additional Statement 56

The communication system according to additional statement 55, characterized in that the network includes a plurality of cells based on a system in which a common pilot channel signal and user transmitted signals are code-division-multiplexed, wherein, assuming that the communication load is an average number of concurrently multiplexed users u, the wireless communication terminal estimates the average number of concurrently multiplexed users u by using a following equation:

$$u = \frac{\frac{{p}_{l}}{{E}_{c} / {N}_{o} ( l )} - Noise}{{\sum }_{k = 1}^{K} {p}_{k}} - 1 \qquad [ Math . 16 ]$$

where k is a cell number, K is a number of cells, p is RSCP, Noise is noise power within a band, Ec/No(I) is Ec/No of an l-th cell, and I is an arbitrary natural number not larger than K, which specifies a cell.

### Additional Statement 57

The communication system according to any one of additional statements 51 to 56, characterized in that the network includes a plurality of cells, wherein cells to be used for estimation of the communication load are limited depending on magnitudes of measured values of at least one quality index of the first and second quality indexes.

### Additional Statement 58

The communication system according to additional statement 57, characterized in that cells to be used for estimation of the communication load are limited to those cells with the measured values of the quality index larger than a predetermined value.

### Additional Statement 59

The communication system according to additional statement 57, characterized in that cells to be used for estimation of the communication load are limited to a predetermined number of top cells in descending order of the measured value of the quality index.

### Additional Statement 60

The communication system according to additional statement 57, characterized in that cells to be used for estimation of the communication load are limited to those cells with the measured values of the quality index, differences of which from the largest one are smaller than a predetermined value.

### Additional Statement 61

The communication system according to any one of additional statements 51 to 60, characterized in that measured values are obtained by measuring at least one of the first and second quality indexes more than once at different times, and the communication load of the network is estimated by using statistical values of these measured values.

### Additional Statement 62

The communication system according to additional statement 61, characterized in that the wireless communication terminal determines a statistical setting value for calculating the statistical values, based on a magnitude of variation of the measured values over time.

### Additional Statement 63

The communication system according to additional statement 62, characterized in that the statistical setting value is a number of the measured values and/or a weighing coefficient on the measured values.

### Additional Statement 64

The communication system according to any one of additional statements 51 to 60, characterized in that every time the wireless communication terminal measures the first and second quality indexes more than once at different times, the wireless communication terminal estimates a first communication load by using respective measured values thereof and, based on a plurality of the first communication loads, determines the communication load of the network.

### Additional Statement 65

The communication system according to additional statement 64, characterized in that the wireless communication terminal calculates statistical values of the plurality of first communication loads as the communication loads on the network.

### Additional Statement 66

The communication system according to additional statement 65, characterized in that the wireless communication terminal determines a statistical setting value for calculating the statistical values, based on a magnitude of variation of the plurality of first communication loads over time.

### Additional Statement 67

The communication system according to additional statement 66, characterized in that the statistical setting value is a number of the first communication loads and/or a weighting coefficient on the first communication loads.

### Additional Statement 68

The communication system according to additional statement 64, characterized in that the wireless communication terminal selects one of the plurality of first communication loads as the communication load of the network in accordance with a predetermined criterion.

### Additional Statement 69

The communication system according to additional statement 68, characterized in that the wireless communication terminal selects a largest, smallest, or median value of the plurality of first communication loads in accordance with the predetermined criterion.

### Additional Statement 70

The communication system according to any one of additional statements 51 to 69, characterized in that the wireless communication terminal estimates a communication load of at least one network and selects the network by using at least the estimated communication load.

### Additional Statement 71

The communication system according to additional statement 70, characterized in that the wireless communication terminal selects the network, depending on the estimated communication load and accuracy of the estimation.

### Additional Statement 72

The communication system according to additional statement 70, characterized in that the wireless communication terminal selects the network, depending on the estimated communication load and priorities of the networks.

### Additional Statement 73

The communication system according to additional statement 70, characterized in that the wireless communication terminal selects the network, depending on the estimated communication load and reception quality of the networks.

### Additional Statement 74

The communication system according to any one of additional statements 70 to 73, characterized in that the wireless communication terminal estimates the communication load of the at least one network, based on measured values of the first and second quality indexes of the at least one network.

### Additional Statement 75

The communication system according to additional statement 74,

characterized in that the wireless communication terminal measures the first and second quality indexes of at least one first network and, based on measured values thereof, estimates a communication load of the first network,

another wireless communication terminal wirelessly connected to the wireless communication terminal measures the first and second quality indexes of at least one second network, estimates a communication load of the second network based on measured values thereof, and sends it to the wireless communication terminal, and

the wireless communication terminal selects a network by using the communication load of the first network and the communication load of the second network.

### Additional Statement 76

The communication system according to additional statement 74,

characterized in that the wireless communication terminal measures the first and second quality indexes of at least one first network,

another wireless communication terminal wirelessly connected to the wireless communication terminal measures the first and second quality indexes of at least one second network and sends them to the wireless communication terminal, and

the wireless communication terminal, upon receiving quality index measured values of the second network, estimates communication loads on the plurality of networks based on quality index measured values of the first network and the quality index measured values of the second network, and selects a network to connect to by using estimated values of the communication loads.

### Additional Statement 77

The wireless communication terminal according to additional statement 43, characterized by further comprising:

reception quality measurement means for measuring reception quality by using a signal from at least one first network,

wherein simplified radio quality information on at least one second network is acquired from another wireless communication terminal wirelessly connected to the wireless communication terminal, and the network selection means selects the network, based on the simplified radio quality information, a measured value of the reception quality, and a communication load of the first network estimated by the load estimation means.

### Additional Statement 78

The communication system according to additional statement 70,

characterized in that the wireless communication terminal measures reception quality by using a signal from at least one first network, acquires simplified radio quality information on at least one second network from another wireless communication terminal wirelessly connected to the wireless communication terminal, and selects the network based on the simplified radio quality information, a measured value of the reception quality, and a communication load of the first network estimated by the load estimation means.

### INDUSTRIAL APPLICABILITY

The present invention is applicable to wireless communication terminals such as mobile routers or smartphones having tethering functionality and mobile communication systems using the same.

### REFERENCE SIGNS LIST

10, 10a, 10b Wireless communication terminal
100, 100a, 100b, 100c, 100d Wireless communication terminal
200a, 200b, 200c, 200d Wireless communication terminal
11 Wireless communication section
12 First quality index measurement section
13 Second quality index measurement section
14 Load estimation section
15 Statistical processing section
16 Data processing section

1. A method for estimating a communication load of a network,
wherein a wireless communication terminal estimates the communication load of the network by using a first quality index that does not depend on a network communication load and a second quality index that depends on a network communication load.

2. The method according to claim 1, wherein the communication load is estimated by using a ratio between the first quality index and the second quality index.

3. The method according to claim 2, wherein the first quality index is RSRP (Reference Signal Received Power) and the second quality index is RSRQ (Reference Signal Received Quality).

4. The method according to claim 3, wherein the network includes a plurality of cells having a predetermined resource block structure, wherein, taking a resource use rate u as the communication load of the network, the resource use rate u is estimated using a following equation:
$$u = \frac{1}{5} {( \frac{\frac{{p}_{l}}{{q}_{l}} - Noise}{2 {\sum }_{k = 1}^{K} {p}_{k}} - 1 )}_{4} \qquad [ Math . 1 ]$$
where k is a cell number, K is a number of cells, p is RSRP, q is RSRQ, l is an arbitrary natural number not larger than K, which specifies a cell, and Noise is noise power per resource block.

5. The method according to claim 2, wherein the first quality index is RSCP (Reference Signal Code Power) and the second quality index is Ec/No (Energy per chip/Noise).

6. The method according to claim 5, wherein the network includes a plurality of cells based on a system in which a common pilot channel signal and user transmitted signals are code-division-multiplexed, wherein, taking an average number of concurrently multiplexed users u as the communication load, the average number of concurrently multiplexed users u is estimated using a following equation:
$$u = \frac{\frac{{p}_{l}}{{E}_{c} / {N}_{o} ( l )} - Noise}{{\sum }_{k = 1}^{K} {p}_{k}} - 1 \qquad [ Math . 2 ]$$
where k is a cell number, K is a number of cells, p is RSCP, Noise is noise power within a frequency band, Ec/No(l) is Ec/No of an l-th cell, and l is an arbitrary natural number not larger than K, which specifies a cell.

7. The method according to claim 1, wherein the network includes a plurality of cells, wherein cells to be used for estimation of the communication load are limited depending on magnitudes of measured values of at least one quality index of the first and second quality indexes.

8. The method according to claim 1, wherein measured values are obtained by measuring at least one of the first and second quality indexes more than once at different times, and the communication load of the network is estimated by using statistical values of these measured values.

9. The method according to claim 1, comprising:
every time the first and second quality indexes are measured more than once at different times, estimating a first communication load by using respective measured values thereof; and
determining the communication load of the network based on a plurality of the first communication loads.

10. The method according to claim 1, wherein the wireless communication terminal estimates communication loads on a plurality of networks.

11. A wireless communication terminal connectable to at least one network, comprising:
a load estimation section that estimates a communication load of the network by using a first quality index that does not depend on a network communication load and a second quality index that depends on a network communication load.

12. The wireless communication terminal according to claim 11, wherein the load estimation section estimates the communication load by using a ratio between the first quality index and the second quality index.

13. The wireless communication terminal according to claim 12, wherein the first quality index is RSRP (Reference Signal Received Power) and the second quality index is RSRQ (Reference Signal Received Quality).

14. The wireless communication terminal according to claim 13, wherein the network includes a plurality of cells having a predetermined resource block structure, wherein, taking a resource use rate u as the communication load of the network, the load estimation section estimates the resource use rate u by using a following equation:
$$u = \frac{1}{5} {( \frac{\frac{{p}_{l}}{{q}_{l}} - Noise}{2 {\sum }_{k = 1}^{K} {p}_{k}} - 1 )}_{7} \qquad [ Math . 3 ]$$
where k is a cell number, K is a number of cells, p is RSRP, q is RSRQ, l is an arbitrary natural number not larger than K, which specifies a cell, and Noise is noise power per resource block.

15. The wireless communication terminal according to claim 12, wherein the first quality index is RSCP (Reference Signal Code Power) and the second quality index is Ec/No (Energy per chip/Noise).

16. The wireless communication terminal according to claim 15, wherein the network includes a plurality of cells based on a system in which a common pilot channel signal and user transmitted signals are code-division-multiplexed, wherein, taking an average number of concurrently multiplexed users u as the communication load, the load estimation section estimates the average number of concurrently multiplexed users u by using a following equation:
$$u = \frac{\frac{{p}_{l}}{{E}_{c} / {N}_{o} ( l )} - Noise}{{\sum }_{k = 1}^{K} {p}_{k}} - 1 \qquad [ Math . 4 ]$$
where k is a cell number, K is a number of cells, p is RSCP, Noise is noise power within a band, Ec/No(l) is Ec/No of an l-th cell, and l is an arbitrary natural number not larger than K, which specifies a cell.

17. The wireless communication terminal according to claim 11, wherein the network includes a plurality of cells, wherein the load estimation section limits cells to be used for estimation of the communication load, depending on magnitudes of measured values of at least one quality index of the first and second quality indexes.

18. The wireless communication terminal according to claim 11, wherein the load estimation section obtains measured values by measuring at least one of the first and second quality indexes more than once at different times, and estimates the communication load of the network by using statistical values of these measured values.

19. The wireless communication terminal according to claim 11, wherein every time the load estimation section measures the first and second quality indexes more than once at different times, the load estimation means estimates a first communication load by using respective measured values thereof and, based on a plurality of the first communication loads, determines the communication load of the network.

20. The wireless communication terminal according to claim 1, further comprising:
a network selection section that selects a network to connect to among a plurality of networks,
wherein the load estimation section estimates a communication load of at least one network, and the network selection section selects the network by using at least the estimated communication load.

21. The wireless communication terminal according to claim 20, further comprising:
a quality index measurement section that measures the first and second quality indexes by receiving signals from the networks individually,
wherein the load estimation section estimates the communication load of the at least one network based on measured values of the first and second quality indexes of the at least one network.

22. The wireless communication terminal according to claim 21,
wherein the quality index measurement section measures the first and second quality indexes of at least one first network, and based on measured values thereof the load estimation section estimates a communication load of the first network, and
when receiving a communication load of at least one second network from another wireless communication terminal wirelessly connected to the wireless communication terminal, the network selection section selects the network by using the communication load of the first network and the communication load of the second network.

23. The wireless communication terminal according to claim 21,
wherein the quality index measurement section measures the first and second quality indexes of at least one first network,
when receiving measured values obtained by another wireless communication terminal wirelessly connected to the wireless communication terminal measuring the first and second quality indexes of at least one second network, the load estimation section estimates communication loads of the plurality of networks based on measured values of the first network and the measured values of the second network, and
the network selection section selects the network to connect to by using the communication loads on the plurality of networks.

24. The wireless communication terminal according to claim 20, further comprising:
a reception quality measurement section that measures reception quality by using a signal from at least one first network,
wherein simplified radio quality information on at least one second network is acquired from another wireless communication terminal wirelessly connected to the wireless communication terminal, and the network selection section selects the network based on the simplified radio quality information, a measure value of the reception quality, and a communication load of the first network estimated by the load estimation section.

25. A communication system comprising at least one network and a wireless communication terminal connectable to the network,
wherein the wireless communication terminal estimates a communication load of the network by using a first quality index that does not depend on a network communication load and a second quality index that depends on a network communication load.
